(19) United States
(12) Patent Application Publication
(10) Pub. No.: US 2025/0247860 A1
(43) Pub. Date: Jul. 31, 2025

(54) MULTIPLE THRESHOLDS FOR COMMUNICATION SYSTEMS WITH BACKSCATTERING-BASED COMMUNICATIONS DEVICES

(71) Applicant: QUALCOMM Incorporated, San Diego, CA (US)

(72) Inventors: Ahmed ELSHAFIE, San Diego, CA (US); Seyedkianoush HOSSEINI, San Diego, CA (US); Yuchul KIM, San Diego, CA (US); Muhammad Sayed Khairy ABDELGHAFFAR, San Jose, CA (US); Zhikun WU, Beijing (CN); Linhai HE, San Diego, CA (US); Huilin XU, Temecula, CA (US); Cong NGUYEN, San Diego, CA (US)

(21) Appl. No.: 18/854,038

(22) PCT Filed: May 16, 2022
(86) PCT No.: PCT/CN2022/092933

§ 371 Date: Oct. 3, 2024

(51) Int. Cl. H04W 72/25; H04W 72/02; H04W 72/542

(52) U.S. Cl. CPC H04W 72/25; H04W 72/02; H04W 72/542

(57) ABSTRACT

A UE may receive an SCI for a first transmission. The UE may select a threshold value for a channel metric threshold. A first threshold value may be selected for the channel metric threshold if the SCI indicates that the first transmission is associated with a backscattering-based communications device. A second threshold value may be selected for the channel metric threshold if the SCI indicates that the first transmission is not associated with the backscattering-based communications device. The first threshold value may be different from the second threshold value. The UE may measure at least a portion of the first transmission to generate a channel metric for the first transmission. The UE may transmit a second transmission using resources selected based on the channel metric and the channel metric threshold.

### TECHNICAL FIELD

The present disclosure relates generally to communication systems, and more particularly, to communication networks with backscattering-based communications devices.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may have a memory and at least one processor coupled to the memory. Based at least in part on information stored in the memory, the at least one processor may be configured to receive a sidelink control information (SCI) for a first transmission. The at least one processor may also be configured to select a threshold value for a channel metric threshold. A first threshold value may be selected for the channel metric threshold if the SCI indicates that the first transmission is associated with a backscattering-based communications device. A second threshold value may be selected for the channel metric threshold if the SCI indicates that the first transmission is not associated with the backscattering-based communications device. The first threshold value may be different from the second threshold value. The at least one processor may also be configured to measure at least a portion of the first transmission to generate a channel metric for the first transmission. The at least one processor may also be configured to transmit a second transmission using resources selected based on the channel metric and the channel metric threshold.

In an aspect of the disclosure, a method, a computer-readable medium, and an apparatus are provided. The apparatus may have a memory and at least one processor coupled to the memory. Based at least in part on information stored in the memory, the at least one processor may be configured to transmit an SCI for a transmission. The SCI may indicate that the transmission is associated with a backscattering-based communications device. The at least one processor may also be configured to transmit the transmission.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 illustrates example aspects of a sidelink slot structure, in accordance with various aspects of the present disclosure.

FIG. 5A is a diagram illustrating an example of a wireless communications system having a backscattering-based communications device that may reflect or backscatter a signal a first UE to a second UE.

FIG. 5B is a diagram illustrating an example of a radio wave transmitted by a wireless communications device.

FIG. 5C is a diagram illustrating an example of a backscattered signal that modulates the radio wave of FIG. 5B.

FIG. 5D is a diagram illustrating an example of a superposition of the radio wave of FIG. 5B and the radio wave of FIG. 5C.

FIG. 6A is a diagram illustrating an example of a wireless communications system having a transmitting UE configured to ensure that a receiving UE may read data from a backscattering-based communications device when the transmitting UE transmits a signal to another UE.

FIG. 6B is the diagram of FIG. 6A where the transmitting UE is also configured to transmit ensure that a receiving UE may read data from a backscattering-based communications device when the transmitting UE transmits a signal to another backscattering-based communications device.

FIG. 7 shows a connection flow diagram of a UE that receives SCI and transmits a signal using resources selected based on the received SCI.

FIG. 8 is a flowchart of a method of wireless communication.

FIG. 9 is another flowchart of a method of wireless communication.

FIG. 10 is another flowchart of a method of wireless communication.

FIG. 11 is another flowchart of a method of wireless communication.

FIG. 12 is another flowchart of a method of wireless communication.

FIG. 13 is a diagram illustrating an example of a hardware implementation for an example apparatus and/or network entity.

### DETAILED DESCRIPTION

Backscattering-based communications devices, such as RFID tags, may be configured to reflect and/or backscatter a wireless signal from a wireless communications device, such as a UE or a TRP. A reflected or backscattered signal from a backscattering-based communications device may not be as strong as the original signal, since such backscattering-based communications devices may use lower power than the originating device (i.e., a low power backscattering-based communications device). Thus, a receiving device may not successfully decode a reflected or backscattered signal from a backscattering-based communications device if there is interference from another transmitting device.

A UE transmitting a sidelink transmission used to read data from a backscattering-based communications device may transmit an SCI for a transmission. The SCI may indicate that the transmission is associated with a backscattering-based communications device. The UE may transmit the transmission. A UE receiving the SCI and the transmission may use the SCI information to ensure that a receiving UE may read data from the backscattering-based communications device.

A receiving UE configured to ensure that another UE may read data from the backscattering-based communications device may receive an SCI for a first transmission. The receiving UE may select a threshold value for a channel metric threshold. A first threshold value may be selected for the channel metric threshold if the SCI indicates that the first transmission is associated with a backscattering-based communications device. A second threshold value may be selected for the channel metric threshold if the SCI indicates that the first transmission is not associated with the backscattering-based communications device. The first threshold value may be different from the second threshold value. The receiving UE may measure at least a portion of the first transmission to generate a channel metric for the first transmission. The receiving UE may transmit a second transmission using resources selected based on the channel metric and the channel metric threshold to ensure that another UE may read data from the backscattering-based communications device.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media may include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

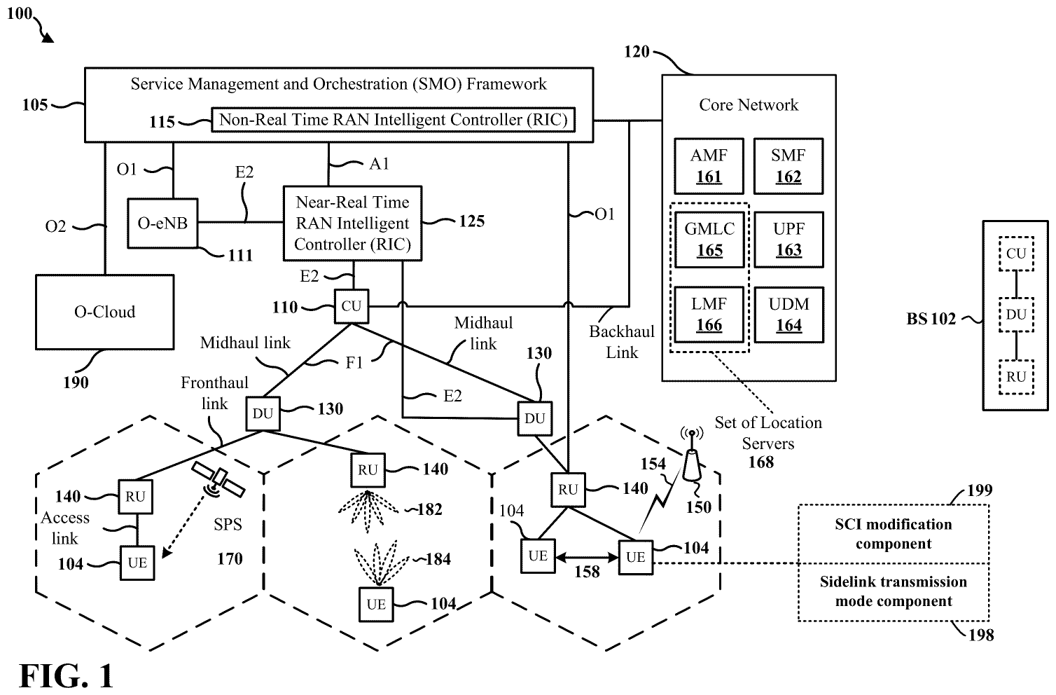

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR. The UEs 104 may be connected to one another using a PC5 interface to maintain the D2D communication link 158.

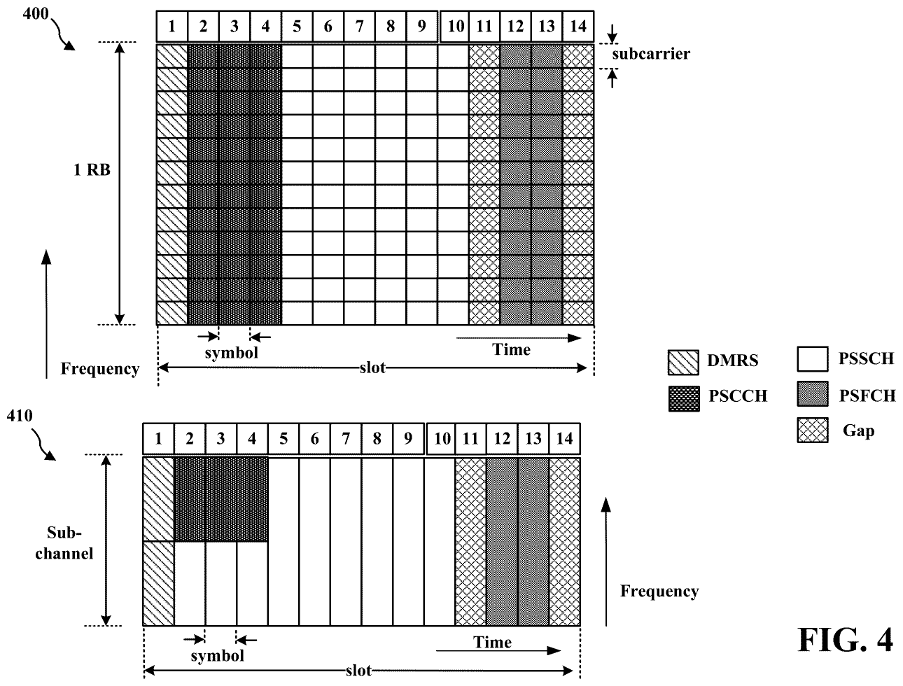

Some examples of sidelink communication may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. A V2X communication may include a basic safety message (BSM) Sidelink communication may be based on V2X or other D2D communication, such as Proximity Services (ProSe), etc. In addition to UEs, sidelink communication may also be transmitted and received by other transmitting and receiving devices, such as Road Side Unit (RSU) 107, etc. Sidelink communication may be exchanged using a PC5 interface, such as described in connection with the example in FIG. 4. Although the following description, including the example slot structure of FIG. 4, may provide examples for sidelink communication in connection with 5G NR, the concepts described herein may be applicable to other similar areas, such as LTE, LTE-A, CDMA, GSM, and other wireless technologies.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may be configured to utilize a sidelink transmission mode component 198 configured to receive SCI for a first transmission and to select a threshold value for a channel metric threshold. A first threshold value may be selected for the channel metric threshold if the SCI indicates that the first transmission is associated with a backscattering-based communications device. A second threshold value may be selected for the channel metric threshold if the SCI indicates that the first transmission is not associated with the backscattering-based communications device. The first threshold value may be different from the second threshold value. The sidelink transmission mode component 198 may also be configured to measure at least a portion of the first transmission to generate a channel metric for the first transmission. The sidelink transmission mode component 198 may also be configured to transmit a second transmission using resources selected based on the channel metric and the channel metric threshold. In certain aspects, the UE 104 may be configured to utilize an SCI modification component 199 configured to transmit an SCI for a transmission. The SCI may indicate that the transmission is associated with a backscattering-based communications device. The SCI modification component 199 may further transmit the transmission. Although the following description may be focused on 5G NR, the concepts described herein may be applicable to other similar areas, such as LTE, LTE-A, CDMA, GSM, and other wireless technologies.

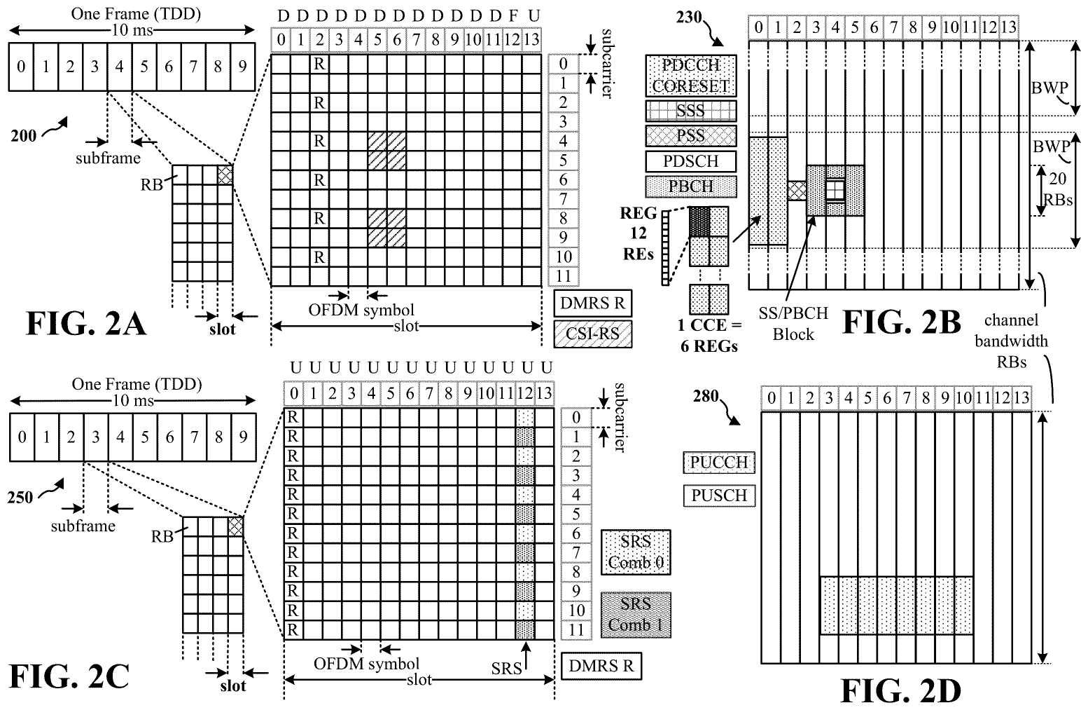

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15 [kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 24*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

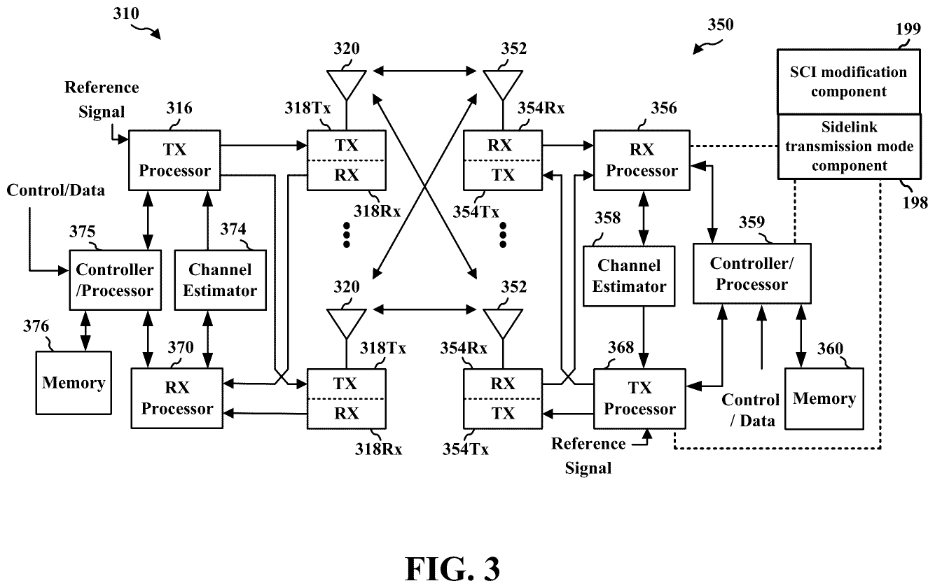

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the sidelink transmission mode component 198 of FIG. 1.

FIG. 4 includes diagrams 400 and 410 illustrating example aspects of slot structures that may be used for sidelink communication (e.g., communication link 158 between UEs 104). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 4 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 400 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may include 10, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 410 in FIG. 4 illustrates an example in which the PSCCH occupies about 50% of a subchannel, as one example to illustrate the concept of PSCCH occupying a portion of a subchannel. The physical sidelink shared channel (PSSCH) occupies at least one subchannel. The PSCCH may include a first portion of sidelink control information (SCI), and the PSSCH may include a second portion of SCI in some examples.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 4, some of the REs may include control information in PSCCH and some REs may include demodulation RS (DMRS). At least one symbol may be used for feedback. FIG. 4 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may include the data message described herein. The position of any of the data, DMRS, SCI, feedback, gap symbols, and/or LBT symbols may be different than the example illustrated in FIG. 4. Multiple slots may be aggregated together in some aspects.

Backscattering-based communications devices, such as RFID tags, may be configured to reflect and/or backscatter a wireless signal from a wireless communications device, such as a UE or a TRP. Such backscattering-based communications devices may be passive, active, semi-passive, and/or semi-active devices. A backscattering-based communications device may be an IoT device. A reflected or backscattered signal from a backscattering-based communications device may not be as strong as the original signal, since such backscattering-based communications devices may use a lower transmission power than the originating device (i.e., a low power backscattering-based communications device). Thus, a receiving device may not successfully decode a reflected or backscattered signal from a backscattering-based communications device if there is interference from another transmitting device, such as an interfering transmission from a UE or a TRP. The signal-to-interference-plus-noise ratio (SINR) from a low power backscattering-based communications device may be too low to ensure a successful receipt.

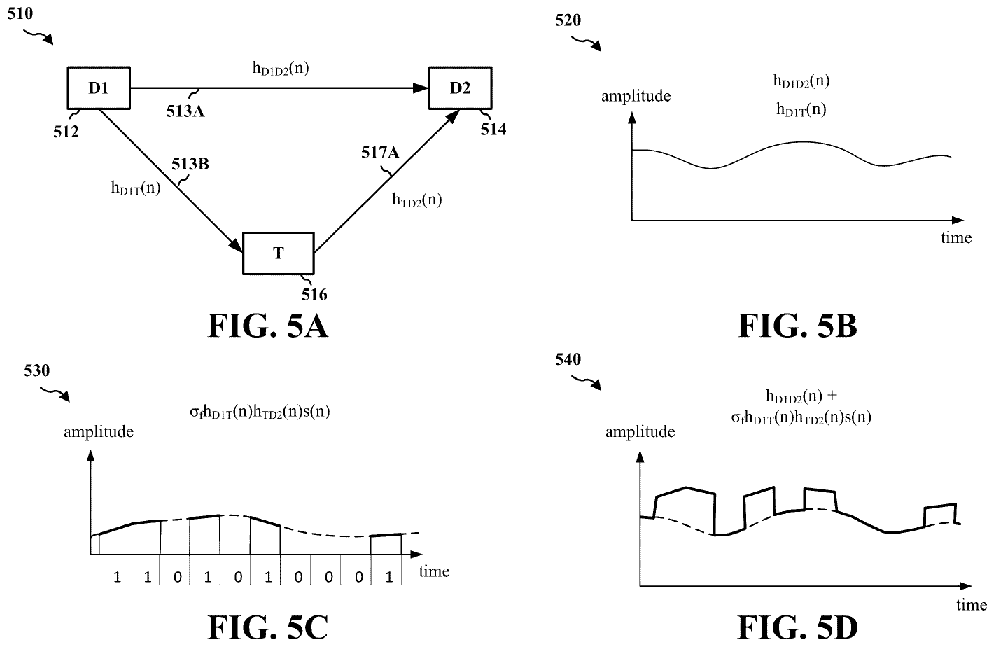

FIG. 5A is a diagram 510 illustrating an example of a wireless communications system having a UE 512 shown as device D1, a UE 514 shown as device D2, and a backscattering-based communications device 516 shown as a tag T that may reflect or backscatter a signal 513B from the UE 512 as a signal 517A to the UE 514. The UE 512 may transmit a signal 513A to the UE 514. The UE 512 may also transmit a signal 513B to the backscattering-based communications device 516. The signal 513A and the signal 513B may be the same signal received contemporaneously by both the UE 514 and the backscattering-based communications device 516. In other words, the UE 512 may be considered an RF source for both the signal 513A and the signal 513B. The UE 512 may transmit a continuous wave (CW), such as a sine wave. While the UE 512 and the UE 514 are depicted as two separate devices in the diagram 510, the UE 512 and the UE 514 may be a full duplex (FD) UE that reads a reflected or backscattered signal from the backscattering-based communications device 516.

The backscattering-based communications device 516 may reflect or backscatter the signal 513B as signal 517A to the UE 514. If the backscattering-based communications device 516 reflects the signal 513B as signal 517A to the UE 514, the signal 517A from the backscattering-based communications device 516 to the UE 514 may reinforce the signal 513A from the UE 512 to the UE 514, strengthening the signal received by the UE 514. If the backscattering-based communications device 516 backscatters the signal 513B as signal 517A to the UE 514, the signal 517A from the backscattering-based communications device 516 to the UE 514 may include an embedded signal (i.e., information bits) from the backscattering-based communications device in addition to the signal received by the UE 514. In other words, the backscattering-based communications device 516 may modulate the received signal 513B with its data sequence. The UE 512 may send one or more queries to the backscattering-based communications device 516, and the backscattering-based communications device 516 may respond to one or more queries by transmitting a re-modulated signal as the signal 517A. The backscattering-based communications device 516 may transmit the signal 517A using any suitable resources, such as a resource having a CW signal. The CW signal may have a CW configuration having a single tone waveform, a multi-tone waveform, an OFDM waveform, or a single carrier (SC) waveform. The SC waveform may be, for example, a single carrier quadrature amplitude modulation (SC-QAM) waveform or a discrete Fourier transform spread orthogonal frequency division multiplexing (DFT-s-OFDM) waveform.

The backscattering-based communications device 516 may be a passive, an active, a semi-passive, or a semi-active IoT device. A passive IoT device may include an energy harvesting (EH) device configured to opportunistically harvest energy in the environment, such as solar, heat, and ambient RF. Such an EH device may have protocol enhancements that support one or more operations using intermittently available energy harvested from the environment. The passive IoT device may store harvested energy using a power storage unit, such as a capacitor or a supercapacitor, which may power RF components, such as the IC, an analog-to-digital converter (ADC), a mixer, and/or an oscillator. The passive IoT device may not have a battery. Variations on the amount of harvested energy and traffic may be expected using such devices. Passive IoT devices that operate using intermittently available energy harvested from the environment may not be able to sustain long, continuous transmission and/or reception. A semi-passive IoT device may have any of the capabilities of a passive IoT device, and may also have a power storage unit, such as a supercapacitor or a battery, that may power and/or turn on an IC of the device. A semi-passive IoT device may also reflect or backscatter an incident signal received by the passive IoT device.

A semi-active IoT device may have any of the capabilities of a passive or a semi-passive IoT device, and may also use its power storage unit to strengthen a received signal, for example by using a power amplifier (PA) that increases an amplitude of the reflected or backscattered signal. An active IoT device may have a power storage unit, such as a battery, that may provide power to one or more active RF components to transmit a signal even when the active IoT device is not within range to receive a signal. An active RF component may strengthen a received signal, for example by using a power amplifier (PA) that increases an amplitude of the reflected or backscattered signal. An active IoT device may even provide a reflected or backscattered signal that is stronger than the signal received by the device, such as the signal 513B received by the backscattering-based communications device 516. An active IoT device may also use its power storage unit to transmit a signal generated by the active IoT device that is not a reflected or a backscattered signal.

The backscattering-based communications device 516 may modulate an incident wave and/or signal using a data sequence. For example, the backscattering-based communications device 516 may use an amplitude shift keying (ASK) modulation method to switch on a reflection when transmitting an information bit “1” and switch off the reflection when transmitting an information bit “0.” For example, FIG. 5B is a diagram 520 illustrating an example of a radio wave transmitted by a wireless communications device, such as the UE 512 in FIG. 5A. FIG. 5C is a diagram 530 illustrating an example of a backscattered signal where the backscattering-based communications device, such as the backscattering-based communications device 516 in FIG. 5A, switches on a reflection when transmitting an information bit “1” and switches off the reflection when transmitting an information bit “0.” FIG. 5D is a diagram 540 illustrating an example of a signal received at a UE, such as the UE 514 in FIG. 5A, which may be a combination of a radio wave transmitted by a wireless communications device, such as the UE 512 in FIG. 5A, and a radio wave transmitted by a backscattering-based communications device, such as the backscattering-based communications device 516 in FIG. 5A.

Each radio wave may be denoted as x (n), such that h_{D1D2} (n) represents a radio wave from the UE 512 to the UE 514, h_{DIT} (n) represents a radio wave from the UE 512 to the backscattering-based communications device 516, and h_{TD2} (n) represents a radio wave from the backscattering-based communications device 516 to the UE 514. Diagram 520 in FIG. 5B shows a radio wave h_{D1D2} (n)/h_{D1T} (n) representing a radio wave transmitted by the UE 512 in FIG. 5A. The UE 514 may receive the radio wave as the signal 513A, denoted as h_{D1D2} (n), and the backscattering-based communications device 516 may receive the radio wave as the signal 513B, denoted as h_{D1T} (n).

The backscattering-based communications device 516 may use an ASK modulation method to switch on a reflection when transmitting an information bit “1” and switch off the reflection when transmitting an information bit “0.” The information bits of the backscattering-based communications device 516 may be denoted as s (n) ∈ {0,1}. Diagram 530 in FIG. 5C shows a radio wave σ_{f}h_{D1T} (n) h_{TD2} (n) s (n) representing a backscattered radio wave of the radio wave in diagram 520 in FIG. 5B, where the backscattering-based communications device 516 in FIG. 5A switches on reflection when transmitting an information bit “1” and switches off reflection when transmitting an information bit “0.” of may denote the reflection coefficient of the backscattering-based communications device 516. The backscattering-based communications device 516 may transmit the radio wave as the signal 517A, denoted as h_{TD2} (n), to the UE 514.

The UE 514 in FIG. 5A may receive a combination of the signal 513A, shown as the radio wave h_{D1D2} (n) in FIG. 5B, and the signal 517A, shown as the radio wave σ_{f}h_{D1T} (n) h_{TD2} (n) s (n) in FIG. 5C. Diagram 540 in FIG. 5C shows a radio wave h_{D1D2} (n)+σ_{f}h_{D1T} (n) h_{TD2} (n) s (n) representing the combination of the radio wave h_{D1D2} (n) of diagram 510 in FIG. 5B and the radio wave σ_{f}h_{D1T} (n) h_{TD2} (n) s (n) of diagram 520 in FIG. 5C. The UE 514 may then decode the combination radio wave to read the transmission from the UE 512, and also read information bits from the backscattering-based communications device 516. In other words, the UE 514 may estimate the envelope of the signal 517A, and the envelope may represent information bits from the backscattering-based communications device 516.

The complete signal received by the UE 514 in FIG. 5A may be represented by y (n)=(h_{D1D2} (n)+σ_{f}h_{D1T} (n) h_{TD2} (n) s (n))× (n)+noise, where noise represents signals received from other wireless devices using resources that overlap the transmissions from the UE 512 and the backscattering-based communications device 516. When s (n)=0, the backscattering-based communications device 516 may switch off reflection, so that the UE 514 only receives the direct link signal 513A from the UE 512, represented by y (n)=h_{D1D2} (n)× (n)+noise. When s (n)=1, the backscattering-based communications device 516 may switch on reflection, so that the UE 514 receives the superposition of both the direct link signal as signal 513A from the UE 512 and the backscatter link signal as signal 517A from the backscattering-based communications device 516, represented by y (n)=(h_{D1D2} (n)+σ_{f}h_{D1T} (n) h_{TD2} (n) s (n))× (n)+noise.

The superposition of a direct link signal from a UE and a backscattered signal from a low-power backscattering-based communications device may not be significantly different from the direct link signal alone since the backscattered signal may be far weaker than the direct link signal (e.g., a backscattered CW signal may be 5× weaker than a direct link CW signal). For example, if the distance between the UE 512 in FIG. 5A and the backscattering-based communications device 516 is 10 m, and the distance between the backscattering-based communications device 516 and the UE 514 is 10 m, then the power difference between the signal 513A and the signal 517A may be 16 dB. If the distance between the UE 512 in FIG. 5A and the backscattering-based communications device 516 is 20 m, and the distance between the backscattering-based communications device 516 and the UE 514 is 20 m, then the power difference between the signal 513A and the signal 517A may be 30 dB. This may be a large dynamic range for an ADC of a low power device to separate the backscattered signal from the direct link signal. In other words, if the aforementioned noise (i.e., SINR) is too high, the receiving device may be unable to successfully decode the information bits from the backscattering-based communications device. Thus, other devices transmitting signals that may be received by a UE decoding a backscattered signal (e.g., the UE 514 in FIG. 5A) may be configured to refrain from, or at least reduce, transmissions when such a backscattered signal is detected. For example, a UE transmitting sidelink transmissions may refrain from, or at least reduce, transmissions in response to another UE transmitting a sidelink transmission used to read data from a backscattering-based communications device.

A UE transmitting a sidelink transmission used to read data from a backscattering-based communications device may transmit an SCI for a transmission. The SCI may indicate that the transmission is associated with a backscattering-based communications device. The UE may transmit the transmission. A UE receiving the SCI and the transmission may use the SCI information to ensure that a receiving UE may read data from the backscattering-based communications device.

A receiving UE configured to ensure that another UE may read data from the backscattering-based communications device may receive an SCI for a first transmission. The receiving UE may select a threshold value for a channel metric threshold. A first threshold value may be selected for the channel metric threshold if the SCI indicates that the first transmission is associated with a backscattering-based communications device. A second threshold value may be selected for the channel metric threshold if the SCI indicates that the first transmission is not associated with the backscattering-based communications device. The first threshold value may be different from the second threshold value. The receiving UE may measure at least a portion of the first transmission to generate a channel metric for the first transmission. The receiving UE may transmit a second transmission using resources selected based on the channel metric and the channel metric threshold to ensure that another UE may read data from the backscattering-based communications device.

Sidelink communication may be based on different types or modes of resource allocation mechanisms. In a first resource allocation mode (which may be referred to herein as “Mode 1”), centralized resource allocation may be provided by a network entity. For example, a base station may determine resources for sidelink communication and may allocate resources to different UEs to use for sidelink transmissions. In this first mode, a UE receives the allocation of sidelink resources from the base station. In a second resource allocation mode (which may be referred to herein as “Mode 2”), distributed resource allocation may be provided. In Mode 2, each UE may autonomously determine resources to use for sidelink transmission. In order to coordinate the selection of sidelink resources by individual UEs, each UE may use a sensing technique to monitor for resource reservations by other sidelink UEs and may select resources for sidelink transmissions from unreserved resources. Devices communicating based on sidelink, may determine one or more radio resources in the time and frequency domain that are used by other devices in order to select transmission resources that avoid collisions with other devices. The sidelink transmission and/or the resource reservation may be periodic or aperiodic, where a UE may reserve resources for transmission in a current slot and up to two future slots (discussed below).

Thus, in the second mode (e.g., Mode 2), individual UEs may autonomously select resources for sidelink transmission, e.g., without a central entity such as a base station indicating the resources for the device. A first UE may reserve the selected resources in order to inform other UEs about the resources that the first UE intends to use for sidelink transmission(s).

In some examples, the resource selection for sidelink communication may be based on a sensing-based mechanism. For instance, before selecting a resource for a data transmission, a UE may first determine whether resources have been reserved by other UEs.

For example, as part of a sensing mechanism for resource allocation mode 2, the UE may determine (e.g., sense) whether the selected sidelink resource has been reserved by other UE(s) before selecting a sidelink resource for a data transmission. If the UE determines that the sidelink resource has not been reserved by other UEs, the UE may use the selected sidelink resource for transmitting the data, e.g., in a PSSCH transmission. The UE may estimate or determine which radio resources (e.g., sidelink resources) may be in-use and/or reserved by others by detecting and decoding sidelink control information (SCI) transmitted by other UEs. The UE may use a sensing-based resource selection algorithm to estimate or determine which radio resources are in-use and/or reserved by others. The UE may receive SCI from another UE that includes reservation information based on a resource reservation field in the SCI. The UE may continuously monitor for (e.g., sense) and decode SCI from peer UEs. The SCI may include reservation information, e.g., indicating slots and RBs that a particular UE has selected for a future transmission. The UE may exclude resources that are used and/or reserved by other UEs from a set of candidate resources for sidelink transmission by the UE, and the UE may select/reserve resources for a sidelink transmission from the resources that are unused and therefore form the set of candidate resources. The UE may continuously perform sensing for SCI with resource reservations in order to maintain a set of candidate resources from which the UE may select one or more resources for a sidelink transmission. Once the UE selects a candidate resource, the UE may transmit SCI indicating its own reservation of the resource for a sidelink transmission. The number of resources (e.g., sub-channels per subframe) reserved by the UE may depend on the size of data to be transmitted by the UE. Although the example is described for a UE receiving reservations from another UE, the reservations may also be received from an RSU or other device communicating based on sidelink.

The UE may measure at least a portion of a transmission to generate a channel metric associated with the transmission. The channel metric may be, for example, a reference signal receive power (RSRP), a received signal received quality (RSRQ), an SINR, a number of retransmissions, a T400 timer, a number of consecutive HARQ discontinuous transmissions (DTXs), or an integrity check measurement. The measurement may be used to select appropriate resources for a transmission to minimize interference with a signal from a backscattering-based communications device. For example, the UE may consider resources reserved in a transmission for which the UE measures an RSRP below a threshold to be available for use by the UE, and not available for use if the measured RSRP is above the threshold. The UE may consider resources not available if the UE measures a number of retransmissions of a received signal to be above a threshold value, and may consider those resources to be available if the UE measures the number of retransmissions of the received signal to be below the threshold value. The UE may perform signal/channel measurement for a sidelink resource that has been reserved and/or used by another UE(s), such as by measuring the associated signal measurement of the message (e.g., the measurement may be a measurement of the SCI, or a measurement of a transmission or resource scheduled by the SCI) that reserves the sidelink resource. The measurement may be a measurement of SCI DM-RS or PSSCH DM-RS, for example. In some aspects, the measurement may be an RSRP measurement of the DM-RS transmitted the SCI. In some aspects, the measurement may be an RSRP measurement of the DM-RS transmitted with the PSSCH.

Based at least in part on the signal/channel measurement of the SCI or a transmission/resource scheduled by the SCI, the UE may consider using/reusing the sidelink resource that has been reserved by other UE(s) or a different resource. For example, the UE may exclude the reserved resources from a candidate resource set if the channel metric meets or exceeds a threshold, and the UE may consider a reserved resource to be available if the channel metric is below the threshold. The UE may select a threshold value for a channel metric threshold based at least in part on the signal/channel measurement of the SCI or a transmission/resource scheduled by the SCI. For example, the UE may include the resources in the candidate resources set and may use/reuse such reserved resources when the message reserving the resources has an RSRP below the threshold because the low RSRP indicates that the other UE is distant and a reuse of the resources is less likely to cause interference to that UE. A higher RSRP may indicate that the transmitting UE that reserved the resources is potentially closer to the UE and may experience higher levels of interference if the UE selected the same resources. By using a first threshold value if the SCI indicates the first transmission is associated with a backscattering-based communications device and a second threshold value if the SCI indicates the first transmission is not associated with a backscattering-based communications device, the UE may alter how it allocates resources based upon environmental variables affecting the transmission, such as whether the transmission is helping a tag or whether the transmission is destined for a UE. When the first transmission is associated with a backscattering-based communications device, the UE may use a specified threshold that allows it to exclude the resources reserved for the backscattering-based communication, minimizing interference to the backscattering-based communication.

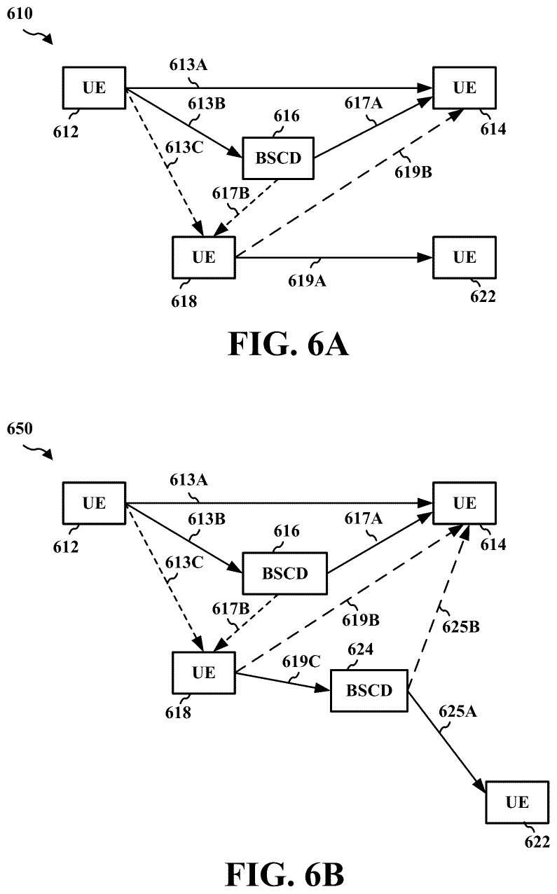

FIG. 6A is a diagram 610 illustrating an example of a wireless communications system having a UE (the UE 618) configured to ensure that a receiving UE (the UE 614) may read data from a backscattering-based communications device (the backscattering-based communications device 616). The wireless communications system in FIG. 6A has a UE 612, a UE 614, and a backscattering-based communications device 616 that may reflect or backscatter a signal 613B from the UE 612 as a signal 617A to the UE 514. The UE 618 may transmit a signal 619A to the UE 622 such that the incident noise 619B to the UE 614 does not interfere with the UE 614 receiving the signal 617A from the backscattering-based communications device 616.

The UE 612 may transmit a sidelink transmission, such as the radio wave in diagram 520 in FIG. 5B. The sidelink transmission from the UE 612 may be received as a signal 613A from the UE 612 to the UE 614, as a signal 613B from the UE 612 to the backscattering-based communications device 616, and/or as an incidental signal 613C to the UE 618. An incidental signal may be a signal that is received by a device that is not a destination for the signal. For example, the incidental signal 613C may have an SCI having a group destination ID that designates the backscattering-based communications device 616 and/or the UE 614 as a receiver, but does not designate the UE 618 as a receiver. In one aspect, the sidelink transmission may not be received by the UE 614 as signal 613A (e.g., if the UE 614 is too far from the UE 612). The incidental signal 613C may have an SCI, such as an SCI-1 transmitted using PSCCH and/or an SCI-2 transmitted using PSSCH. The UE 618 may decode a portion of the SCI of the incidental signal 613C to determine attributes of the sidelink transmission, such as the signal 613A and/or the signal 613B.

The backscattering-based communications device 616 may reflect or backscatter the signal 613B as a sidelink transmission, such as the radio wave in diagram 540 in FIG. 5D. The sidelink transmission from the backscattering-based communications device 616 may be received as a signal 617A from the backscattering-based communications device 616 to the UE 614 and as incidental signal 617B from the backscattering-based communications device 616 to the UE 618. The incidental signal 617B may have a SCI (e.g., SCI-1, SCI-2). The UE 618 may decode a portion of the SCI of the incidental signal 617B to determine attributes of the sidelink transmission, such as the signal 617A.

The SCI of the incidental signal 613C or the incidental signal 617B may include a tag class, an indicator of a destination device (e.g., a group destination ID, an identifier of the backscattering-based communications device 616, an identifier of the UE 614), an indicator of a UE capability (e.g., a UE capability of the UE 614), a UE type (e.g., a make and/or model of a UE, an indicator of whether the UE is able or not able to cancel a CW signal or resource), an indicator of a frequency configuration (e.g., resource block assignment and hopping resource allocation), one or more indicators of one or more threshold values for one or more channel metrics, and/or an indicator of one or more threshold increment values for at least one channel metric threshold. The SCI may include an SCI-1 that contains information for resource allocation of a transmission, such as the signal 613A from the UE 612 or the signal 617A from the backscattering-based communications device 616.

A tag class may include, for example, a tag type, an indicator of a reflection power, an indicator of a reflection ability, an indicator of energy loss, an indicator of a frequency configuration (e.g., a set of resources used by a backscattering-based communications device for transmission), an indicator of one or more CW frequencies used by a backscattering-based communications device, or an indicator of a frequency range. An indictor may include data or an index to the data. For example, an indicator of a UE capability may include a capability of the UE 614, or may include an identifier of the UE 614 (e.g., a unique identifier or a type of the UE), which may be used to determine the UE capability by referencing an index of UE identifiers and UE capabilities. The UE 618 may have been RRC configured with the UE 614, may have received UE capability of the UE 614 during the RRC configuration, may have saved the UE capability to an index that associates the UE capability of an identifier of the UE 614, and may receive an indicator that identifies the UE 614 as the destination for the signal 613A or as the destination for a reflected or backscattered signal of the signal 613B. The UE 618 may determine the UE capability of the UE 614 by cross-referencing the indicator that identifies the UE 614 with the received UE capability of the UE 614 indexed by the indicator. In another aspect, an indicator of one or more threshold values may include a set of threshold values or may include index numbers that reference threshold values provided in a previous RRC configuration to the UE 618.

The UE 618 may determine resources to use for its transmission of the signal 619A based on a channel metric (e.g., an RSRP, an RSRQ, an SINR) of an incidental signal 613C received by the third UE as compared to an threshold value. For example, the UE 618 may exclude resources from a candidate set for transmission by the UE 618 if the signal associated with the SCI has a measured RSRP above a channel metric threshold for the RSRP. The UE 618 may measure a channel metric of the incidental signal 613C and/or may measure a channel metric of the incidental signal 617B and compare the measured channel metric against a channel metric threshold to determine a transmission behavior. For example, in response to the measured RSRP meeting or being lower than an RSRP channel metric threshold, the UE 618 may use resources that overlap with the resources of the incidental signal 613C (e.g., the same CW signal, the same time period) in its transmission of the signal 619A to the UE 622. Similarly, in response to the measured RSRP meeting or being higher than an RSRP channel metric threshold, the UE 618 may not use resources that overlap with the resources of the incidental signal (e.g., a different CW signal/frequency, a different time period) in its transmission of the signal 619A to the UE 622 by excluding the reserved resources from a candidate set of resources from which the UE selects the resources for its transmission. While the UE 618 may be configured to use resources that overlap with the resources of the incidental signal 613C when the measured channel metric is below the channel metric threshold, in some aspects the UE 618 may be configured to use resources that overlap with the resources of the incidental signal 613C when the measured channel metric is above the channel metric threshold. For example, if the channel metric is a number of retransmissions of the incidental signal 613C, the UE 618 may be configured to use resources that overlap with the resources of the incidental signal 613C when the number of retransmissions of the incidental signal 613C is less than the channel metric threshold. In some aspects, the UE 618 may select a threshold range to trigger a behavior, for example a first threshold range to trigger using a first set of resources, a second threshold range to trigger using a second set of resources, and a third threshold range to trigger using a third set of resources.

The channel metric threshold may be different for one incidental signal verses another incidental signal. For example, an incidental signal received from a UE might use a channel metric threshold value that is higher than a channel metric threshold value used for an incidental signal received from a backscattering-based communications device. Signals from backscattering-based communications devices may be weaker than signals from UE. For example, the UE 618 may give priority to transmissions from backscattering-based communications devices by using a lower RSRP threshold or a higher number of retransmissions threshold for transmissions from backscattering-based communications devices.

The UE 618 may define multiple channel metric threshold values for the same priority level, for example a higher channel metric threshold value and a lower channel metric threshold value for the same priority level. For example, a lower RSRP threshold value may have less dB than the higher RSRP threshold value. The UE 618 may select a channel metric threshold from the plurality of channel metric threshold values based on SCI data (e.g., SCI-1 and/or SCI-2 from the incidental signal 613C and/or incidental signal 617B).

The SCI of the incidental signal 613C or the SCI of the incidental signal 617B may include a tag class of the backscattering-based communications device 616. The UE 618 may select a channel metric threshold value based on a reflection ability of the tag class. The reflection ability may provide an indication of the amount of signal that is reflected by the backscattering-based communications device 616, or may provide an indication of an amount of the signal that may be boosted by the backscattering-based communications device 616, for example by a PA RF component. The more power the backscattering-based communications device 616 can reflect (i.e., higher reflection ability), the better the SINR may be (e.g., higher range) when the UE 614 receives the signal 617A. As such, the ability of the tag class may be used by the UE 618 to select a channel metric threshold. For example, the UE 618 may select a higher threshold value for an RSRP channel metric threshold when the reflection ability of the tag class is higher, and may select a lower threshold value for an RSRP channel metric threshold when the reflection ability of the tag class is lower. In another aspect, the UE 618 may select a higher threshold value for a HARQ DTX channel metric threshold when the reflection ability of the tag class is lower, and may select a lower threshold value for a HARQ DTX channel metric threshold when the reflection ability of the tag class is higher.

Similarly, the UE 618 may select a channel metric threshold value based on an energy loss of the tag class (e.g., an amount of energy consumed by the device). The energy loss may provide an indication of the amount of energy that is lost when the backscattering-based communications device 616 reflects or backscatters the signal 613B from the UE 612. For example, the UE 618 may select a lower threshold value for an RSRP channel metric threshold when the energy loss of the tag class is higher, and may select a higher threshold value for an RSRP channel metric threshold when the energy loss of the tag class is lower. In another aspect, the UE 618 may select a lower threshold value for a HARQ DTX channel metric threshold when the energy loss of the tag class is lower, and may select a higher threshold value for a HARQ DTX channel metric threshold when the energy loss of the tag class is higher.

The UE 618 may select a channel metric threshold value based on a CW frequency configuration of the tag class. For example, the CW frequency configuration may provide a frequency range of the signal 617A transmitted by the backscattering-based communications device 616. The more the frequency range overlaps with the resources used by the UE 618 to transmit the signal 619A, the lower the SINR may be. For example, the UE 618 may select a higher threshold value for an RSRP channel metric threshold when the CW frequency configuration indicates more overlap between the resources used by the signal 617A and the signal 619A, and may select a lower threshold value for an RSRP channel metric threshold when the CW frequency configuration indicates less overlap between the resources used by the signal 617A and the signal 619A. In another aspect, the UE 618 may select a higher threshold value for a HARQ DTX channel metric threshold when the CW frequency configuration indicates less overlap between the resources used by the signal 617A and the signal 619A, and may select a lower threshold value for a HARQ DTX channel metric threshold when the CW frequency configuration indicates more overlap between the resources used by the signal 617A and the signal 619A.

The SCI of the incidental signal 613C or the SCI of the incidental signal 617B may include an indicator of the UE capability of the UE 614 that receives the signal 617A from the backscattering-based communications device 616. The UE capability may include a UE decoding capability of the UE 614, for example the capability of the UE 614 to decode very low power signals. The dynamic range of the UE 614 may provide an indicator of an ability to decode the signal 617A under interference from the incident noise 619B. The UE decoding capability may be used to select a channel metric threshold. For example, the UE 618 may select a higher threshold value for an RSRP channel metric threshold to exclude reserved resources from a candidate set of transmission resources when the UE decoding capability of the UE 614 is higher, and may select a lower threshold value for an RSRP channel metric threshold to exclude reserved resources from a candidate set of transmission resources when the UE decoding capability of the UE 614 is lower. In another aspect, the UE 618 may select a higher threshold value for a HARQ DTX channel metric threshold to exclude reserved resources from a candidate set of transmission resources when the UE decoding capability of the UE 614 is lower, and may select a lower threshold value for a HARQ DTX channel metric threshold to exclude reserved resources from a candidate set of transmission resources when the UE decoding capability of the UE 614 is higher.

The indicator of the UE capability in the SCI of the incidental signal 617B may directly provide an indication of the decoder capability and/or ability to decode under high interference, for example by providing a metric of the dynamic range of the UE 614 or by providing a flag value that indicates whether or not the UE 614 has interference cancellation capabilities. In another aspect, the indicator of the UE capability in the SCI of the incidental signal 617B or the incidental signal 613C may indirectly provide an indication of the UE capability of the UE 614 by providing a destination ID that is associated with a certain decoder capability and/or a dynamic range. The UE 618 may have communicated with the UE 614, for example via an RRC connection, which may provide the UE 618 with relationships between the destination ID in the SCI and a UE capability (e.g., the UE 614 and the UE 618 may exchange IDs).

The SCI of the incidental signal 613C or the SCI of the incidental signal 617B may include an indicator of a presence of the backscattering-based communications device 616 (e.g., a source ID or a destination ID associated with the backscattering-based communications device 616) or an operation to read from the backscattering-based communications device 616. The SCI of the incidental signal 613C from the UE 612 may indicate the UE 612 is helping a backscattering-based communications device. The SCI of the incidental signal 613C from the UE 612 may be used to select a channel metric threshold. For example, the UE 618 may select a lower threshold value for an RSRP channel metric threshold to exclude reserved resources from a candidate set of transmission resources when the SCI indicates the presence of a backscattering-based communications device (e.g., the UE 612 is helping a tag), and may select a higher threshold value for an RSRP channel metric threshold to exclude reserved resources from a candidate set of transmission resources when the SCI does not indicate the presence of a backscattering-based communications device (e.g., the UE is transmitting a signal directly to another UE). In another aspect, the UE 618 may select a lower threshold value for a HARQ DTX channel metric threshold to exclude reserved resources from a candidate set of transmission resources when the SCI does not indicate the presence of a backscattering-based communications device, and may select a higher threshold value for a HARQ DTX channel metric threshold to exclude reserved resources from a candidate set of transmission resources when the SCI indicates the presence of a backscattering-based communications device.

The UE 612 may be similarly configured as the UE 618. For the example the UE 612 may similarly select a channel metric threshold from a plurality of channel metric threshold values, e.g., for the exclusion of reserved resources from a candidate set of transmission resources, based on information in an SCI received from a signal transmitted by the UE 618 to ensure that a sidelink transmission from the UE 612 does not unduly interfere with receipt of the signal 619A at the UE 622.

FIG. 6B is a diagram 650 illustrating an example of a wireless communications system having a UE (the UE 618) configured to ensure that a receiving UE (the UE 614) may read data from a backscattering-based communications device (the backscattering-based communications device 616) when the UE 618 sends a signal 619C to another backscattering-based communications device (the backscattering-based communications device 624). The wireless communications system in FIG. 6B has a UE 612, a UE 614, and a backscattering-based communications device 616 that may reflect or backscatter a signal 613B from the UE 612 as a signal 617A to the UE 614. The wireless communications system in also has a UE 618, a UE 622, and a backscattering-based communications device 624 that may reflect or backscatter a signal 619C from the UE 618 as a signal 625A to the UE 622.

If both the UE 612 and the UE 618 are both helping a tag, then the interference to the UE 614 when receiving the signal 617A may not be high. The incident noise 619B from the UE 618 to the UE 614 may be minimal, as the UE 618 may be transmitting the signal 619C to the backscattering-based communications device 624 using transmission having a CW configuration, such as a single tone (e.g., the signal 619C may be a CW transmission) or a deterministic reference signal which may be easier to cancel than other signals. The UE 614 may have an analog filter that enables the UE 614 to remove interference from a CW signal, such as single tones. Moreover, the incident noise 625B from the backscattering-based communications device 624 to the UE 614 may also be minimal, as backscattering-based communications devices tend to be low power devices (comparatively to UE devices). An indication of whether a UE is transmitting a sidelink transmission to a backscattering-based communications device may be used to select a channel metric threshold. For example, the UE 618 may select a lower threshold value for an RSRP channel metric threshold to exclude reserved resources from a candidate set of transmission resources when the SCI indicates that the UE 612 is transmitting a sidelink transmission to a backscattering-based communications device (e.g., the UE 612 is transmitting a signal indirectly to the UE 614 via signal 613B), and may select a higher threshold value for an RSRP channel metric threshold to exclude reserved resources from a candidate set of transmission resources when the SCI does not indicate that the UE 612 is transmitting a sidelink transmission to a backscattering-based communications device (e.g., the UE 612 is transmitting a signal directly to the UE 614 via signal 613A). In another aspect, the UE 618 may select a higher threshold value for a HARQ DTX channel metric threshold in response to determining that the UE 612 is transmitting a signal 613A having a destination ID that is associated with the UE 614, and may select a lower threshold value for the HARQ DTX channel metric threshold in response to determining that the UE 612 is transmitting a signal 613B having a destination ID that is associated with the backscattering-based communications device 616.

The UE 614 may have a UE capability to cancel a CW signal. Such a UE capability may be associated with a type of UE that may be indicated to the UE 618 by an SCI in the incidental signal 613C or the incidental signal 617B. In one aspect, the indicator of a UE capability may be a binary flag, or indication, that indicates whether or not the UE 614 is able to cancel a CW signal. The UE capability may indicate what kinds of resources the UE 614 may cancel, for example the range of frequencies that the UE 614 may be configured to cancel, or an indicator of tag types (as defined in a tag class) whose transmissions the UE 614 may be configured to cancel.

In one aspect, a binary indicator of a UE capability that indicates whether or not the UE 614 is able to cancel a CW signal indicates that the UE 614 is able to cancel any CW signal having a destination ID associated with the UE 614. In response to the indicator of the UE capability indicating that the UE 614 is able to cancel a CW signal, the UE 618 may transmit the signal 619C to the backscattering-based communications device 624 using a resource that overlaps with a CW signal of the incidental signal 613C or the incidental signal 617B.

In one aspect, a binary indicator of a UE capability that indicates whether or not the UE 614 is able to cancel a CW signal indicates that the UE 614 is able to cancel any CW signal defined by a specification, for example a specification for a type of UE indicated by an SCI where the type of UE is associated with the UE 614, or a specification for a tag class where the tag class is associated with the backscattering-based communications device 616. The tag class may be associated with a set of frequency configurations that the backscattering-based communications device 616 may use to transmit. The UE 618 may transmit the signal 619C to the backscattering-based communications device 624 using a resource that overlaps with the set of frequency configurations associated with the tag class of the backscattering-based communications device 616. In another aspect, the UE 618 may transmit the signal 619C to the backscattering-based communications device 624 using a resource that overlaps with the set of frequency configurations associated with the tag class of the backscattering-based communications device 616, but does not overlap with the resources used by the incidental signal 613C and/or incidental signal 617B. For example, the UE 618 may exclude the resources reserved for the incidental signals 613C and/or 617B from a set of candidate resources from which the UE 618 selects its transmission resources.

In one aspect, the UE 618 may select a channel metric threshold value for the channel metric threshold based on whether the UE 618 receives an indication that the UE 612 is transmitting a signal 613B to the backscattering-based communications device 616, and/or whether the UE 618 receives an indication that the UE 614 has the capability to cancel CW signals. Such indications, alone or together, may be used to select a channel metric threshold. For example, if the UE receives both an indication that the UE 612 is transmitting a signal 613B to the backscattering-based communications device 616 and an indication that the UE 614 has the capability to cancel a set of CW signals that may be transmitted by the UE 614, the UE 618 may select a lower threshold value for an RSRP channel metric threshold. In another aspect, if the UE receives both an indication that the UE 612 is transmitting a signal 613B to the backscattering-based communications device 616 and an indication that the UE 614 has the capability to cancel CW signal, the UE 618 may select a higher threshold value for a HARQ DTX channel metric threshold. The UE 618 may transmit the signal 619C using CW signals that correlate with the UE capability of the UE 614 to cancel CW signals.

In one aspect, in response to the UE 618 receiving an indication that the UE 612 is transmitting a signal 613B to the backscattering-based communications device 616, and in response to the UE 618 preparing to transmit a signal 619C to the backscattering-based communications device 624 (i.e., the third UE is helping a tag), the UE 618 may select a lower threshold value for an RSRP channel metric threshold to exclude reserved resources from a candidate set of transmission resources. The UE 618 may transmit the signal 619C knowing that the incident noise 625B to the UE 614 will not interfere much with the signal 617A to the UE 614.

In one aspect, the measured RSRP value of the incidental signal 613C or the incidental signal 617B in FIG. 6A or FIG. 6B may be higher than a selected RSRP channel metric threshold, prompting the UE 618 to use a transmission resource that does not overlap with the incidental signal by excluding the resources reserved for the incidental signal 613C and/or the incidental signal 617B from a set of candidate sidelink transmission resources. The UE 618 may be configured to find available resources, for example a resource that has 20% resource availability. In response to the UE 618 failing to find an available resource, the UE 618 may be configured to increase the RSRP channel metric threshold by an RSRP channel metric threshold increment, for example by 3 dB, and try again. The UE 618 may be configured to select a threshold increment similarly to how the UE 618 selected the channel metric threshold. For example, the UE 618 may use a smaller increment in response to the RSRP channel metric threshold corresponding with a determination that the destination ID of the incidental signal 613C is associated with the UE 614, and may use a larger increment in response to the RSRP threshold corresponding with a determination that the destination ID of the incidental signal 613C is associated with backscattering-based communications device 616.

An increment value may be used to increment or decrement a threshold value for a channel metric threshold. For example, where the channel metric is a HARQ DTX, the increment value may be used to decrement the threshold value by the threshold increment in response to determining that available resources that do not overlap with the first transmission are less than or equal to a resource threshold.

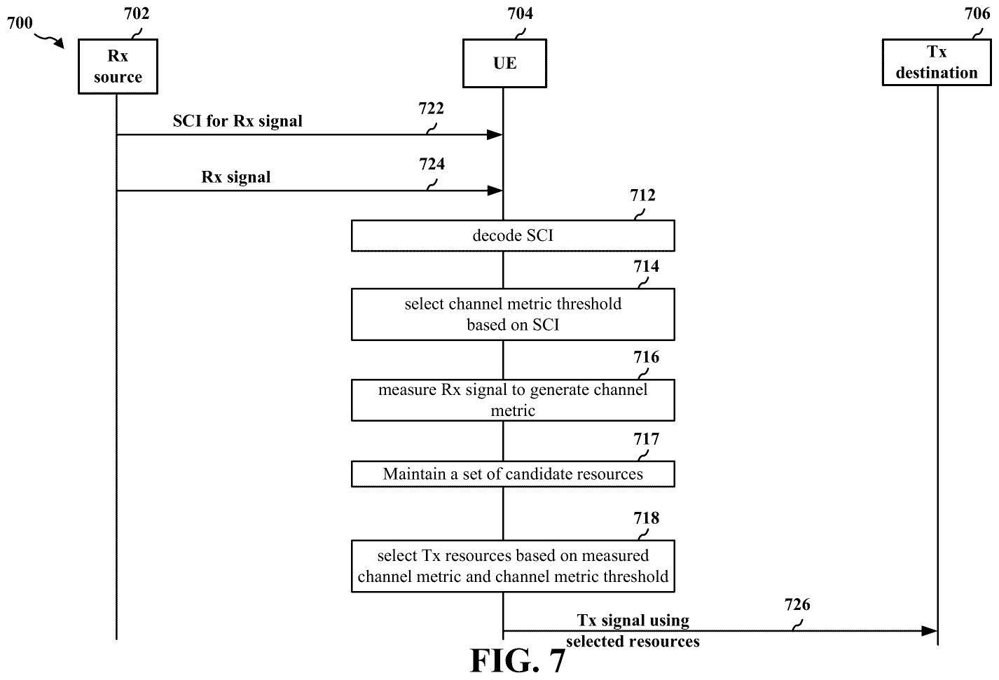

In FIG. 7 a connection flow diagram 700 has a UE 704 that receives SCI 722 for an Rx signal 724 from an Rx source 702 and transmits a Tx signal 726 to a Tx destination 706 using resources selected based on the received SCI 722. The Rx source 702, the UE 704, and the Tx destination 706 may communicate with one another using a sidelink channel, for example by using the D2D communication link 158 in FIG. 1. The Rx source 702 may be a UE, such as the UE 612 in FIGS. 6A and 6B, or a backscattering-based communications device, such as the backscattering-based communications device 616 in FIGS. 6A and 6B. The Tx destination 706 may be a UE, such as the UE 622 in FIGS. 6A and 6B, or any wireless communication device that may receive the Tx signal 726 from the UE 704.

The UE 704 may receive an SCI 722 for an Rx signal 724 from the Rx source 702, and may receive the Rx signal 724 from the Rx source 702 via a sidelink channel. In one aspect, the SCI 722 and the Rx signal 724 may share a slot, for example a slot having a PSCCH with SCI-1 and a PSSCH with SCI-2 and data that may be decoded using the SCI. In another aspect, the SCI 722 may precede the Rx signal 724 by one or more slots, for example if the SCI 722 schedules an Rx transmission for a future slot.

At 712, the UE 704 may decode the SCI 722 to determine properties of the Rx signal 724, for example a tag class, a UE capability, or one or more channel metric thresholds and channel metric threshold increments, and/or other thresholds or measurements that may be made for the SCI 722 or a transmission/resource scheduled by the SCI 722, such as the Rx signal 724. As explained above, data in the SCI 722 may be used to determine whether it may be desirable to increase or decrease a threshold, for example a channel metric threshold, for determining whether to exclude the resources from a candidate set of transmission resources, and/or increments, such as channel metric threshold increments, based on the presence or absence of one or more backscattering-based communications devices, and based on attributes of the backscattering-based communications device and destination devices for the Rx signal 724. The UE 704 may have a plurality of possible channel metric thresholds to select for the Rx signal 724. At 714, the UE 704 may select a channel metric threshold based on information in the SCI 722 to determine whether it may be desirable to refrain or at least reduce interference noise generated by the Tx signal 726 when a receiving device associated with the SCI receives the Rx signal 724.

At 716, the UE 704 may measure the Rx signal 724 to generate a channel metric, and may compare the measured channel metric to the selected channel metric threshold. As illustrated at 717, the UE 704 may maintain a set of candidate resources from which the UE 704 may select resources for transmission, e.g., resources for a sidelink transmission selected based on mode 2 resource allocation. The UE 704 may exclude resources that are indicated for use by another device, e.g., in a resource reservation of an SCI, and which have a channel metric measurement that meets or exceeds a corresponding channel metric threshold or meets and is less than a corresponding channel metric threshold. The UE 704 may continue to include the reserved resources in the candidate set of sidelink transmission resources based on a comparison of the channel metric measurement against the channel metric threshold. The channel metric threshold may vary based on any of the aspects described in connection with FIG. 5A-6B, 8, or 9. At 718, the UE 704 may select resources from the candidate set of resources for the Tx signal 726 to minimize interference caused by the Tx signal 726 to a receiving device associated with the SCI. For example, the UE 704 may select a CW signal that corresponds with CW signals/frequencies that the receiving device associated with the SCI 722 may be configured to cancel, or the UE 704 may postpone transmission of the Tx signal 726 until after the Rx signal 724 has completed transmission. The UE 704 may then transmit the Tx signal 726 to the Tx destination 706 using the selected resources.

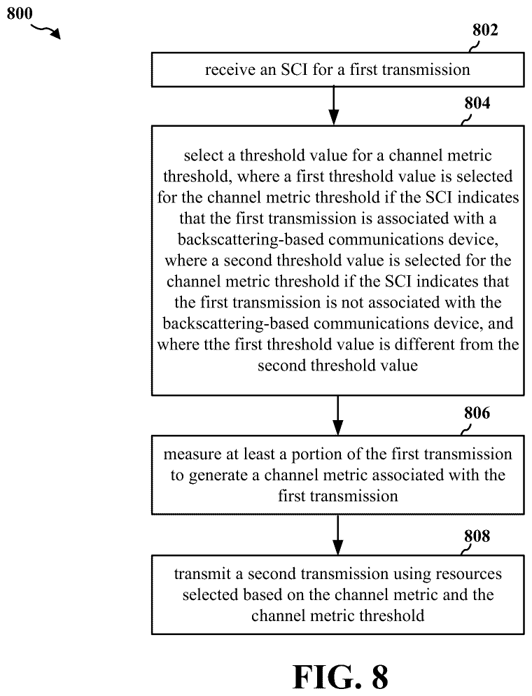

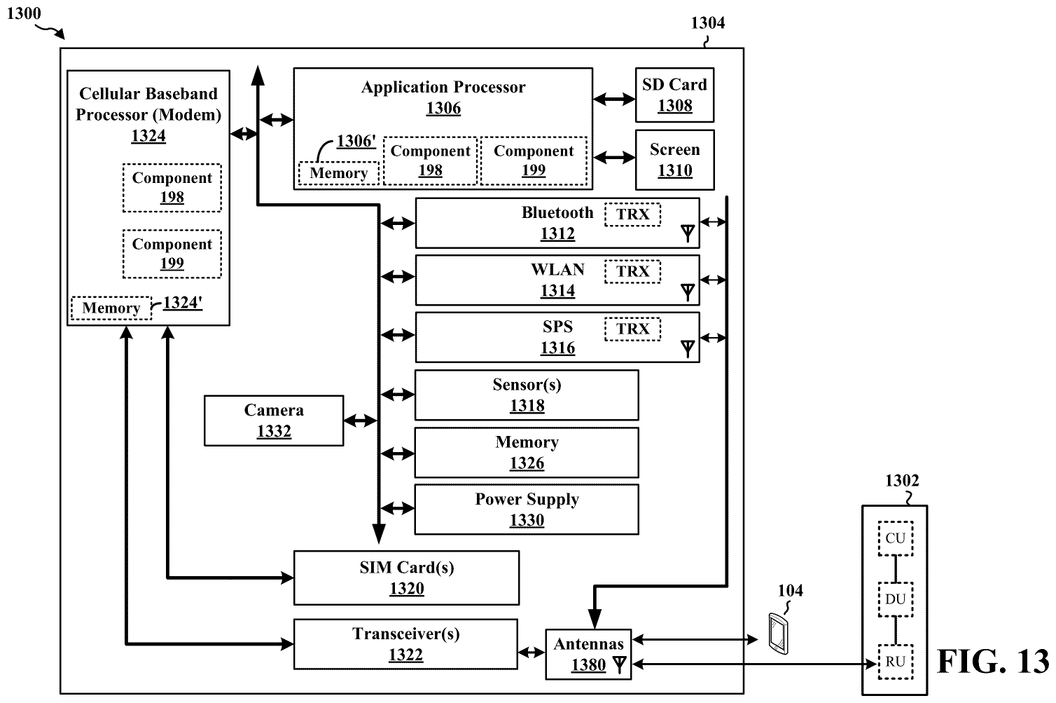

FIG. 8 is a flowchart 800 of a method of wireless communication. The method may be performed by a UE (e.g., the UEs 104, 350, 512, 612, 618, 704; the Rx source 702; the apparatus 1304). At 802, the UE may receive an SCI for a first transmission. For example, the SCI may indicate a resource reservation or scheduling information for the first transmission. For example, 802 may be performed by the UE 618 in FIG. 6A, which may receive an SCI in incidental signal 613C for a signal 613A or 613B, or may receive an SCI in incidental signal 617B for a signal 617A. 802 may also be performed by the apparatus 1304 in FIG. 13.

At 804, the UE may select a threshold value for a channel metric threshold. A first threshold value may be selected for the channel metric threshold if the SCI indicates that the first transmission is associated with a backscattering-based communications device. A second threshold value may be selected for the channel metric threshold if the SCI indicates that the first transmission is not associated with the backscattering-based communications device. The first threshold value may be different from the second threshold value. For example, 804 may be performed by the UE 618 in FIG. 6A by selecting a lower threshold value for an RSRP channel metric threshold if the SCI in the incidental signal 617B indicates that the signal 617A is associated with the backscattering-based communications device 616. 804 may also be performed by the UE 618 in FIG. 6A by selecting a higher threshold value for an RSRP channel metric threshold if the SCI from the incidental signal 613C indicates that the signal 613A is not associated with the backscattering-based communications device 616. 804 may also be performed by the apparatus 1304 in FIG. 13.

At 806, the UE may measure at least a portion of the first transmission to generate a channel metric for the first transmission. For example, 806 may be performed by the UE 618 in FIG. 6A, which may measure at least a portion of the incidental signal 613C to generate a channel metric for the incidental signal 613C. 806 may also be performed by the apparatus 1304 in FIG. 13.

At 808, the UE may transmit a second transmission using resources selected based on the channel metric and the channel metric threshold. For example, 808 may be performed by the UE 618 in FIG. 6A, which may transmit a signal 619A using resources selected based on the channel metric for the incidental signal 613C and the selected channel metric threshold based on the SCI in incidental signal 613C for the signal 613A or 613B, and/or the SCI in incidental signal 617B for the signal 617A. 808 may also be performed by the apparatus 1304 in FIG. 13.

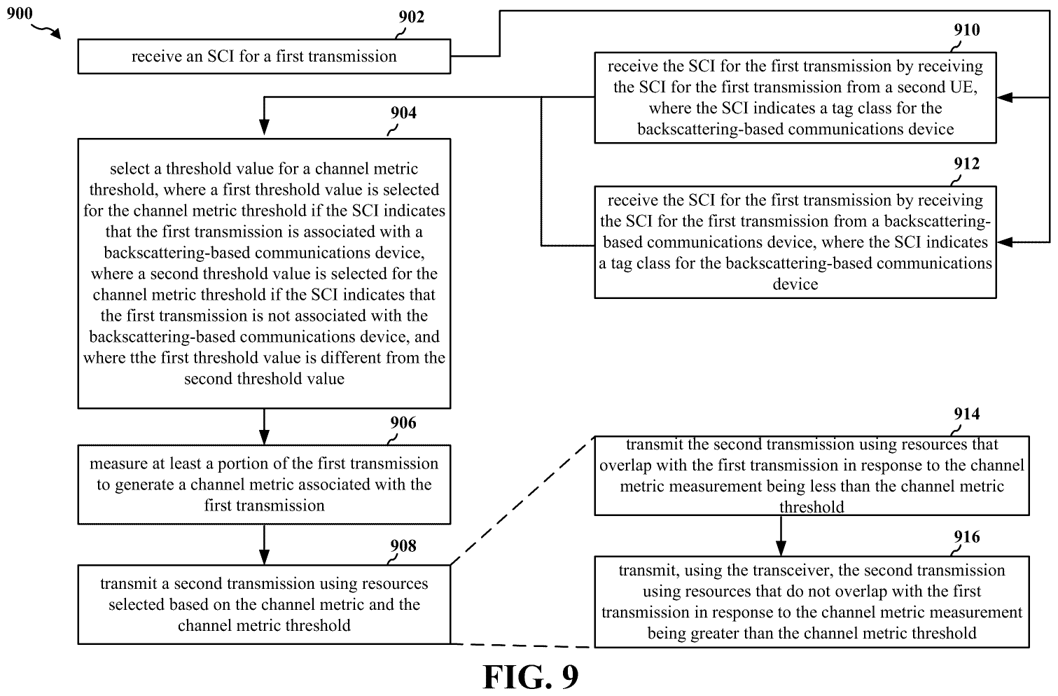

FIG. 9 is a flowchart 900 of a method of wireless communication. The method may be performed by a UE (e.g., the UEs 104, 350, 512, 612, 618, 704; the Rx source 702; the apparatus 1304). At 902, the UE may receive an SCI for a first transmission. For example, the SCI may indicate a resource reservation or scheduling information for the first transmission. For example, 902 may be performed by the UE 618 in FIG. 6A, which may receive an SCI in incidental signal 613C for a signal 613A or 613B, or may receive an SCI in incidental signal 617B for a signal 617A. 902 may also be performed by the apparatus 1304 in FIG. 13.

At 910, the UE may receive the SCI for the first transmission by receiving the SCI for the first transmission from a second UE. The SCI may indicate a tag class for the backscattering-based communications device. For example, 910 may be performed by the UE 618 in FIG. 6A, which may receive an SCI in incidental signal 613C from the UE 612. The SCI in the incidental signal 613C may indicate a tag class for the backscattering-based communications device 616. 910 may also be performed by the apparatus 1304 in FIG. 13.

At 912, the UE may receive the SCI for the first transmission by receiving the SCI for the first transmission from a backscattering-based communications device. The SCI may indicate a tag class for the backscattering-based communications device. For example, 912 may be performed by the UE 618 in FIG. 6A, which may receive an SCI in incidental signal 617B from the backscattering-based communications device 616. The SCI in the incidental signal 617B may indicate a tag class for the backscattering-based communications device 616. 912 may also be performed by the apparatus 1304 in FIG. 13.

At 904, the UE may select a threshold value for a channel metric threshold. A first threshold value may be selected for the channel metric threshold if the SCI indicates that the first transmission is associated with a backscattering-based communications device. A second threshold value may be selected for the channel metric threshold if the SCI indicates that the first transmission is not associated with the backscattering-based communications device. The first threshold value may be different from the second threshold value. For example, 904 may be performed by the UE 618 in FIG. 6A by selecting a lower threshold value for an RSRP channel metric threshold if the SCI in the incidental signal 617B indicates that the signal 617A is associated with the backscattering-based communications device 616. 904 may also be performed by the UE 618 in FIG. 6A by selecting a higher threshold value for an RSRP channel metric threshold if the SCI from the incidental signal 613C indicates that the signal 613A is not associated with the backscattering-based communications device 616. 904 may also be performed by the apparatus 1304 in FIG. 13.

At 906, the UE may measure at least a portion of the first transmission to generate a channel metric for the first transmission. For example, 906 may be performed by the UE 618 in FIG. 6A, which may measure at least a portion of the incidental signal 613C to generate a channel metric for the incidental signal 613C. 906 may also be performed by the apparatus 1304 in FIG. 13.

At 908, the UE may transmit a second transmission using resources selected based on the channel metric and the channel metric threshold. For example, 908 may be performed by the UE 618 in FIG. 6A, which may transmit a signal 619A using resources selected based on the channel metric for the incidental signal 613C and the selected channel metric threshold based on the SCI in incidental signal 613C for the signal 613A or 613B, and/or the SCI in incidental signal 617B for the signal 617A. 908 may also be performed by the apparatus 1304 in FIG. 13.

At 914, the UE may transmit the second transmission using resources that overlap with the first transmission in response to the channel metric measurement being less than the channel metric threshold. For example, 914 may be performed by the UE 618 in FIG. 6A, which may transmit a signal 619A using resources that overlap with the incidental signal 613C from the UE 612 in response to an RSRP channel metric for the incidental signal 613C being less than an RSRP channel metric threshold. 914 may also be performed by the apparatus 1304 in FIG. 13.

At 916, the UE may transmit the second transmission using resources that do not overlap with the first transmission in response to the channel metric measurement being greater than the channel metric threshold. For example, 916 may be performed by the UE 618 in FIG. 6A, which may transmit a signal 619A using resources that do not overlap with the incidental signal 613C from the UE 612 in response to an RSRP channel metric for the incidental signal 613C being greater than an RSRP channel metric threshold. 916 may also be performed by the apparatus 1304 in FIG. 13.

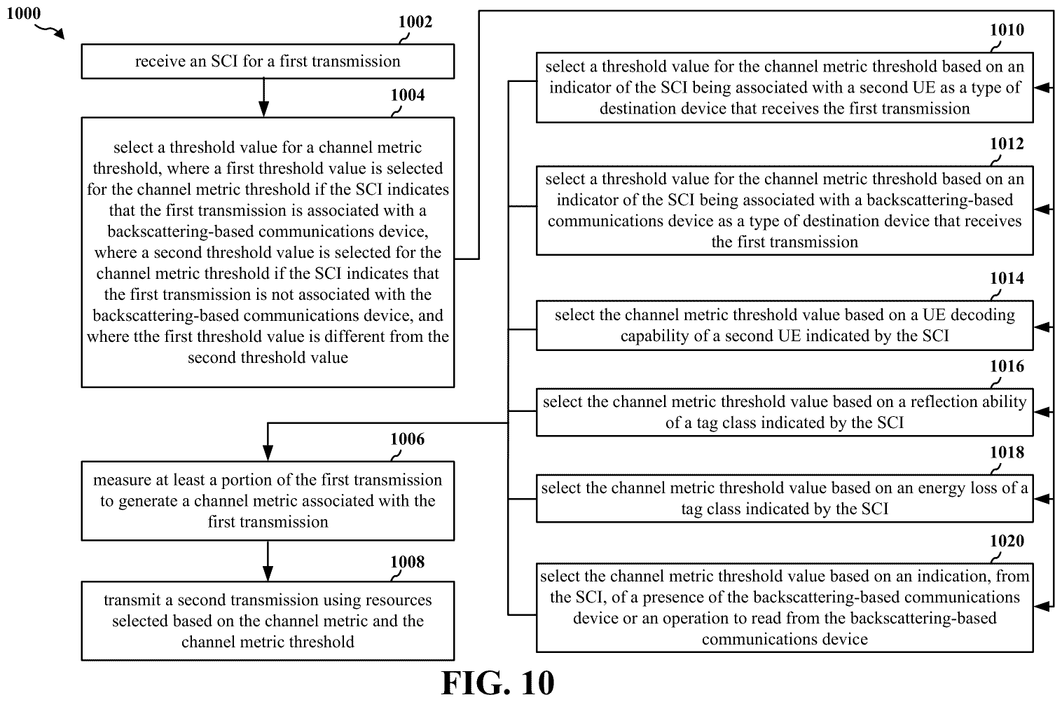

FIG. 10 is a flowchart 1000 of a method of wireless communication. The method may be performed by a UE (e.g., the UEs 104, 350, 512, 612, 618, 704; the Rx source 702; the apparatus 1304). At 1002, the UE may receive an SCI for a first transmission. For example, the SCI may indicate a resource reservation or scheduling information for the first transmission. For example, 1002 may be performed by the UE 618 in FIG. 6A, which may receive an SCI in incidental signal 613C for a signal 613A or 613B, or may receive an SCI in incidental signal 617B for a signal 617A. 1002 may also be performed by the apparatus 1304 in FIG. 13.

At 1004, the UE may select a threshold value for a channel metric threshold. A first threshold value may be selected for the channel metric threshold if the SCI indicates that the first transmission is associated with a backscattering-based communications device. A second threshold value may be selected for the channel metric threshold if the SCI indicates that the first transmission is not associated with the backscattering-based communications device. The first threshold value may be different from the second threshold value. For example, 1004 may be performed by the UE 618 in FIG. 6A by selecting a lower threshold value for an RSRP channel metric threshold if the SCI in the incidental signal 617B indicates that the signal 617A is associated with the backscattering-based communications device 616. 1004 may also be performed by the UE 618 in FIG. 6A by selecting a higher threshold value for an RSRP channel metric threshold if the SCI from the incidental signal 613C indicates that the signal 613A is not associated with the backscattering-based communications device 616. 1004 may also be performed by the apparatus 1304 in FIG. 13.

At 1010, the UE may select a threshold value for the channel metric threshold based on an indicator of the SCI being associated with a second UE as a type of destination device that receives the first transmission. For example, 1010 may be performed by the UE 618 in FIG. 6A selecting a higher threshold value for an RSRP channel metric threshold in response to an indicator of the SCI in incidental signal 613C from the UE 612 being associated with the UE 614 as a type of destination device that receives the incidental signal 613C as the signal 613A. 1010 may also be performed by the apparatus 1304 in FIG. 13.

At 1012, the UE may select a threshold value for the channel metric threshold based on an indicator of the SCI being associated with a backscattering-based communications device as a type of destination device that receives the first transmission. For example, 1012 may be performed by the UE 618 in FIG. 6A selecting a lower threshold value for an RSRP channel metric threshold in response to an indicator of the SCI in incidental signal 613C from the UE 612 being associated with the backscattering-based communications device 616 as a type of destination device that receives the incidental signal 613C as the signal 613B. 1012 may also be performed by the apparatus 1304 in FIG. 13.

At 1014, the UE may select the channel metric threshold value based on a UE decoding capability of a second UE indicated by the SCI. For example, 1014 may be performed by the UE 618 in FIG. 6A selecting the channel metric threshold value for the channel metric threshold based on a UE decoding capability of the UE 614 indicated by the SCI in incidental signal 613C from the UE 612 (e.g., a higher RSRP threshold for a better decoding capability). 1014 may also be performed by the apparatus 1304 in FIG. 13.

At 1016, the UE may select the channel metric threshold value based on a reflection ability of a tag class indicated by the SCI. For example, 1016 may be performed by the UE 618 in FIG. 6A selecting the channel metric threshold value for the channel metric threshold based on a reflection ability of a tag class of the backscattering-based communications device 616 indicated by the SCI in incidental signal 613C from the UE 612 (e.g., a higher RSRP channel metric threshold for a better reflection ability). 1016 may also be performed by the apparatus 1304 in FIG. 13.

At 1018, the UE may select the channel metric threshold value based on an energy loss of a tag class indicated by the SCI. For example, 1018 may be performed by the UE 618 in FIG. 6A selecting the channel metric threshold value for the channel metric threshold based on an energy loss of a tag class of the backscattering-based communications device 616 indicated by the SCI in incidental signal 613C from the UE 612 (e.g., a lower RSRP channel metric threshold for a higher energy loss). 10108 may also be performed by the apparatus 1304 in FIG. 13.

At 1020, the UE may select the channel metric threshold value based on an indication, from the SCI, of a presence of the backscattering-based communications device or an operation to read from the backscattering-based communications device. For example, 1020 may be performed by the UE 618 in FIG. 6A selecting the channel metric threshold value for the channel metric threshold based on an indication, from the SCI in incidental signal 613C from the UE 612, of a presence of the backscattering-based communications device 616 or an operation to read from the backscattering-based communications device 616 (e.g., a higher RSRP channel metric threshold when the presence of the backscattering-based communications device 616 is indicated or an operation to read from the backscattering-based communications device 616 is indicated). 1020 may also be performed by the apparatus 1304 in FIG. 13.

At 1006, the UE may measure at least a portion of the first transmission to generate a channel metric for the first transmission. For example, 1006 may be performed by the UE 618 in FIG. 6A, which may measure at least a portion of the incidental signal 613C to generate a channel metric for the incidental signal 613C. 1006 may also be performed by the apparatus 1304 in FIG. 13.

At 1008, the UE may transmit a second transmission using resources selected based on the channel metric and the channel metric threshold. For example, 1008 may be performed by the UE 618 in FIG. 6A, which may transmit a signal 619A using resources selected based on the channel metric for the incidental signal 613C and the selected channel metric threshold based on the SCI in incidental signal 613C for the signal 613A or 613B, and/or the SCI in incidental signal 617B for the signal 617A. 1008 may also be performed by the apparatus 1304 in FIG. 13.

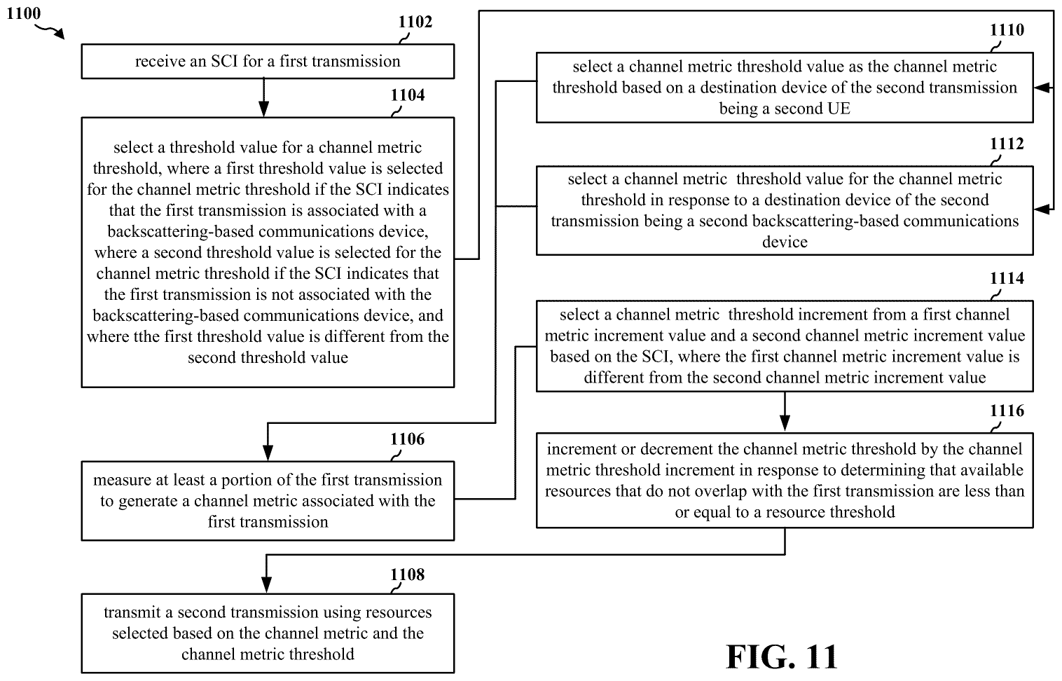

FIG. 11 is a flowchart 1100 of a method of wireless communication. The method may be performed by a UE (e.g., the UEs 104, 350, 512, 612, 618, 704; the Rx source 702; the apparatus 1304). At 1102, the UE may receive an SCI for a first transmission. For example, the SCI may indicate a resource reservation or scheduling information for the first transmission. For example, 1102 may be performed by the UE 618 in FIG. 6A, which may receive an SCI in incidental signal 613C for a signal 613A or 613B, or may receive an SCI in incidental signal 617B for a signal 617A. 1102 may also be performed by the apparatus 1304 in FIG. 13.

At 1104, the UE may select a threshold value for a channel metric threshold. A first threshold value may be selected for the channel metric threshold if the SCI indicates that the first transmission is associated with a backscattering-based communications device. A second threshold value may be selected for the channel metric threshold if the SCI indicates that the first transmission is not associated with the backscattering-based communications device. The first threshold value may be different from the second threshold value. For example, 1104 may be performed by the UE 618 in FIG. 6A by selecting a lower threshold value for an RSRP channel metric threshold if the SCI in the incidental signal 617B indicates that the signal 617A is associated with the backscattering-based communications device 616. 1104 may also be performed by the UE 618 in FIG. 6A by selecting a higher threshold value for an RSRP channel metric threshold if the SCI from the incidental signal 613C indicates that the signal 613A is not associated with the backscattering-based communications device 616. 1104 may also be performed by the apparatus 1304 in FIG. 13.

At 1110, the UE may select a channel metric threshold value as the channel metric threshold based on a destination device of the second transmission being a second UE. For example, 1110 may be performed by the UE 618 in FIG. 6A selecting a higher threshold value for an RSRP channel metric threshold in response to the destination device of the incidental signal 613C as signal 613A being destined for the UE 614. 1110 may also be performed by the apparatus 1304 in FIG. 13.

At 1112, the UE may select a channel metric threshold value for the channel metric threshold in response to a destination device of the second transmission being a second backscattering-based communications device. For example, 1112 may be performed by the UE 618 in FIG. 6A selecting a higher threshold value for an RSRP channel metric threshold in response to the destination device of the incidental signal 613C as signal 613B being destined for the backscattering-based communications device 616. 1112 may also be performed by the apparatus 1304 in FIG. 13.

At 1106, the UE may measure at least a portion of the first transmission to generate a channel metric for the first transmission. For example, 1106 may be performed by the UE 618 in FIG. 6A, which may measure at least a portion of the incidental signal 613C to generate a channel metric for the incidental signal 613C. 1106 may also be performed by the apparatus 1304 in FIG. 13.

At 1114, the UE may select a channel metric threshold increment from a first channel metric increment value and a second channel metric increment value based on the SCI. The first channel metric increment value may be different from the second channel metric increment value. For example, 1114 may be performed by the UE 618 in FIG. 6A, which may select a channel metric threshold increment from a lower channel metric increment value and a higher increment value based on the SCI in the incidental signal 613C from the UE 612. The lower channel metric increment value may be different from the higher RSRP increment value. 1114 may also be performed by the apparatus 1304 in FIG. 13.

At 1116, the UE may increment or decrement the channel metric threshold by the channel metric threshold increment in response to determining that available resources that do not overlap with the first transmission are less than or equal to a resource threshold. For example, 1116 may be performed by the UE 618 in FIG. 6A, which may increment an RSRP channel metric threshold by an RSRP channel metric threshold increment in response to determining that available resources for the signal 619A to UE 622 that do not overlap with the incidental signal 613C from the UE 612 are less or equal to a resource threshold. 1116 may also be performed by the apparatus 1304 in FIG. 13. In another aspect, the UE 618 in FIG. 6A may decrement a HARQ DTX channel metric threshold by a HARQ DTX channel metric threshold increment in response to determining that available resources for the signal 619A to UE 622 that do not overlap with the incidental signal 613C from the UE 612 are less or equal to a resource threshold.

At 1108, the UE may transmit a second transmission using resources selected based on the channel metric and the channel metric threshold. For example, 1108 may be performed by the UE 618 in FIG. 6A, which may transmit a signal 619A using resources selected based on the channel metric for the incidental signal 613C and the selected channel metric threshold based on the SCI in incidental signal 613C for the signal 613A or 613B, and/or the SCI in incidental signal 617B for the signal 617A. 1108 may also be performed by the apparatus 1304 in FIG. 13.

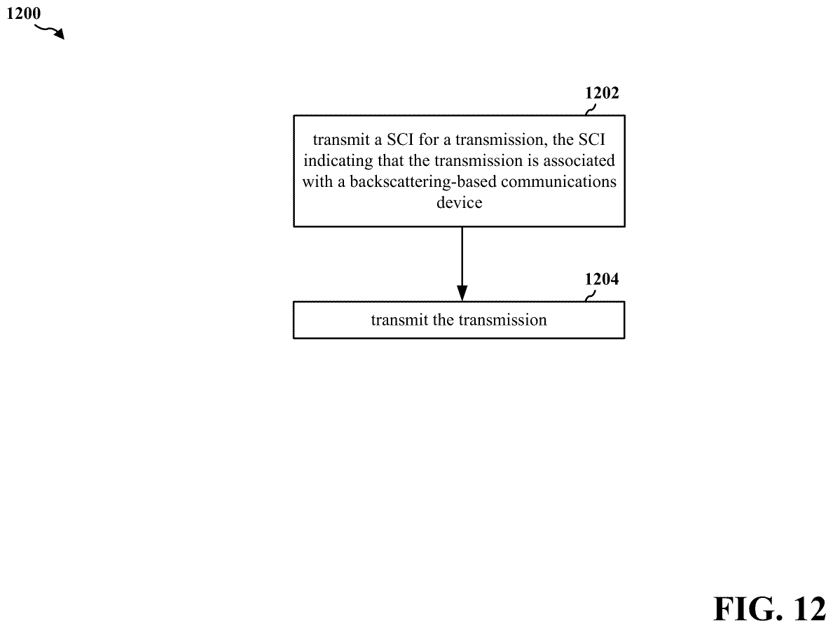

FIG. 12 is a flowchart 1200 of a method of wireless communication. The method may be performed by a UE (e.g., the UEs 104, 350, 512, 612, 618, 704; the backscattering-based communications devices 516, 616, 624; the Rx source 702; the apparatus 1304). At 1202, the wireless communications device may transmit a SCI for a transmission, the SCI indicating that the transmission is associated with a backscattering-based communications device. For example, 1202 may be performed by the backscattering-based communications device 616 in FIG. 6A, which may transmit an SCI in incidental signal 617B for the signal 617A indicating that the transmission is associated with the backscattering-based communications device 616 as a source device. 1202 may also be performed by the apparatus 1304 in FIG. 13.

At 1204, the wireless communications device may transmit the transmission. For example, 1204 may be performed by the backscattering-based communications device 616 in FIG. 6A, which may transmit the signal 617A to the UE 614. 1204 may also be performed by the apparatus 1304 in FIG. 13.

FIG. 13 is a diagram 1300 illustrating an example of a hardware implementation for an apparatus 1304. The apparatus 1304 may be a UE, a component of a UE, or may implement UE functionality. In some aspects, the apparatus 1004 may include a cellular baseband processor 1324 (also referred to as a modem) coupled to one or more transceivers 1322 (e.g., cellular RF transceiver). The cellular baseband processor 1324 may include on-chip memory 1324′. In some aspects, the apparatus 1304 may further include one or more subscriber identity modules (SIM) cards 1320 and an application processor 1306 coupled to a secure digital (SD) card 1308 and a screen 1310. The application processor 1306 may include on-chip memory 1306′. In some aspects, the apparatus 1304 may further include a Bluetooth module 1312, a WLAN module 1314, an SPS module 1316 (e.g., GNSS module), one or more sensor modules 1318 (e.g., barometric pressure sensor/altimeter; motion sensor such as inertial management unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1326, a power supply 1330, and/or a camera 1332. The Bluetooth module 1312, the WLAN module 1314, and the SPS module 1316 may include an on-chip transceiver (TRX) (or in some cases, just a receiver (RX)). The Bluetooth module 1312, the WLAN module 1314, and the SPS module 1316 may include their own dedicated antennas and/or utilize the antennas 1380 for communication. The cellular baseband processor 1324 communicates through the transceiver(s) 1322 via one or more antennas 1380 with the UE 104 and/or with an RU associated with a network entity 1302. The cellular baseband processor 1324 and the application processor 1306 may each include a computer-readable medium/memory 1324′, 1306′, respectively. The additional memory modules 1326 may also be considered a computer-readable medium/memory. Each computer-readable medium/memory 1324′, 1306′, 1326 may be non-transitory. The cellular baseband processor 1324 and the application processor 1306 are each responsible for general processing, including the execution of software stored on the computer-readable medium/memory. The software, when executed by the cellular baseband processor 1324/application processor 1306, causes the cellular baseband processor 1324/application processor 1306 to perform the various functions described supra. The computer-readable medium/memory may also be used for storing data that is manipulated by the cellular baseband processor 1324/application processor 1306 when executing software. The cellular baseband processor 1324/application processor 1306 may be a component of the UE 350 and may include the memory 360 and/or at least one of the TX processor 368, the RX processor 356, and the controller/processor 359. In one configuration, the apparatus 1304 may be a processor chip (modem and/or application) and include just the cellular baseband processor 1324 and/or the application processor 1306, and in another configuration, the apparatus 1304 may be the entire UE (e.g., see UE 350 of FIG. 3) and include the additional modules of the apparatus 1304.

In some aspects, the apparatus 1304 may have a component 198. As discussed supra, the component 198 is configured to receive an SCI for a first transmission. The component 198 may select an RSRP threshold value for the RERP threshold. The component 198 may select a lower RSRP threshold value for an RSRP threshold if the SCI indicates the first transmission is associated with a backscattering-based communications device. The component 198 may select a higher RSRP threshold value for the RSRP threshold if the SCI indicates that the first transmission is not associated with the backscattering-based communications device. The lower RSRP threshold value may be lower than the higher RSRP threshold value. The component 198 may measure at least a portion of the first transmission to generate an RSRP measurement for the first transmission. The component 198 may transmit a second transmission using resources selected based on the RSRP measurement and the RSRP threshold. The component 198 may be within the cellular baseband processor 1324, the application processor 1306, or both the cellular baseband processor 1324 and the application processor 1306. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1304 may include a variety of components configured for various functions. In one configuration, the apparatus 1304, and in particular the cellular baseband processor 1324 and/or the application processor 1306, includes means for receiving an SCI for a first transmission, means for selecting an RSRP threshold value for an RSRP threshold, means for selecting a lower RSRP threshold value for an RSRP threshold if the SCI indicates the first transmission is associated with a backscattering-based communications device, means for selecting a higher RSRP threshold value for the RSRP threshold if the SCI indicates that the first transmission is not associated with the backscattering-based communications device, means for measuring at least a portion of the first transmission to generate an RSRP measurement for the first transmission, means for transmitting a second transmission using resources selected based on the RSRP measurement and the RSRP threshold, means for transmitting the second transmission using resources that overlap with the first transmission in response to the RSRP measurement being less than the RSRP threshold, means for transmitting the second transmission using resources that do not overlap with the first transmission in response to the RSRP measurement being greater than the RSRP threshold, means for selecting the higher RSRP threshold value for the RSRP threshold in response to the indicator being associated with a second UE that receives the first transmission, means for selecting the lower RSRP threshold value for the RSRP threshold in response to the indicator being associated with the backscattering-based communications device that receives the first transmission, means for selecting the lower RSRP threshold value for the RSRP threshold based on the UE decoding capability of the second UE, means for receiving, from the second UE, information indicating the UE decoding capability, means for selecting the lower RSRP threshold value or the higher RSRP threshold value for the RSRP threshold based on a reflection ability of the tag class, means for selecting the lower RSRP threshold value or the higher RSRP threshold value for the RSRP threshold based on an energy loss of the tag class, means for receiving the SCI for the first transmission by receiving the SCI for the first transmission from a second UE, means for receiving the SCI for the first transmission by receiving the SCI for the first transmission from the backscattering-based communications device, means for selecting the lower RSRP threshold value or the higher RSRP threshold value for the RSRP threshold based on the indication of the presence of the backscattering-based communications device or based on the operation to read from the backscattering-based communications device, means for selecting an RSRP threshold increment from a lower RSRP increment value and a higher RSRP increment value based on the SCI, means for incrementing the RSRP threshold by the RSRP threshold increment in response to determining that available resources that do not overlap with the first transmission are less than or equal to a resource threshold, means for selecting the lower RSRP threshold value or the higher RSRP threshold value for the RSRP threshold by selecting the higher RSRP threshold value as the RSRP threshold in response to a destination device of the second transmission being a second UE, means for selecting the higher RSRP threshold value for the RSRP threshold in response to a destination device of the second transmission being a second backscattering-based communications device, means for selecting a threshold value for a channel metric threshold, means for measuring at least a portion of the first transmission to generate a channel metric associated with the first transmission, means for transmitting a second transmission using resources selected based on the channel metric and the channel metric threshold, means for transmitting the second transmission using resources that overlap with the first transmission in response to the channel metric being less than the channel metric threshold and using resources that do not overlap with the first transmission in response to the channel metric being greater than the channel metric threshold, means for transmitting the second transmission using resources that overlap with the first transmission in response to the channel metric being greater than the channel metric threshold and using resources that do not overlap with the first transmission in response to the channel metric being less than the channel metric threshold, means for selecting a threshold increment from a first increment value and a second increment value based on the SCI, and means for incrementing or decrementing the threshold value by the threshold increment in response to determining that available resources that do not overlap with the first transmission are less than or equal to a resource threshold. The means may be the component 198 of the apparatus 1304 configured to perform the functions recited by the means. As described supra, the apparatus 1304 may include the TX processor 368, the RX processor 356, and the controller/processor 359. As such, in one configuration, the means may be the TX processor 368, the RX processor 356, and/or the controller/processor 359 configured to perform the functions recited by the means.

In some aspects, the apparatus 1304 may have a component 199. The apparatus 1304 may be a UE, such as the UE 612 in FIGS. 6A and 6B, or a backscattering-based communications device, such as the backscattering-based communications device 616 in FIGS. 6A and 6B. As discussed supra, the component 199 is configured to transmit an SCI for a transmission. The SCI may indicate that the transmission is associated with a backscattering-based communications device. The component 199 may also be configured to transmit the transmission. The component 199 may be within the processor 1306. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The apparatus 1304 may include a variety of components configured for various functions. In one configuration, the apparatus 1304 includes means for transmitting a SCI for a transmission, the SCI indicating that the transmission is associated with a backscattering-based communications device, and means for transmitting the transmission. The means may be the component 199 of the apparatus 1304 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including receiving an SCI for a first transmission. The method may further include selecting a threshold value for a channel metric threshold. A first threshold value may be selected for the channel metric threshold if the SCI indicates that the first transmission is associated with a backscattering-based communications device. A second threshold value is selected for the channel metric threshold if the SCI indicates that the first transmission is not associated with the backscattering-based communications device. The first threshold value is different from the second threshold value. The method may further include measuring at least a portion of the first transmission to generate a channel metric associated with the first transmission. The method may further include transmitting a second transmission using resources selected based on the channel metric and the channel metric threshold.

Aspect 2 is the method of aspect 1, further including using resources for the second transmission that overlap with the first transmission in response to the channel metric being less than the channel metric threshold. The method may also include using resources for the second transmission that do not overlap with the first transmission in response to the channel metric being greater than the channel metric threshold.

Aspect 3 is the method of any of aspects 1 and 2, where the SCI includes an indicator associated with a type of destination device that receives the first transmission.

Aspect 4 is the method of aspect 3, where a third threshold value is selected for the channel metric threshold in response to the indicator being associated with a second UE that receives the first transmission.

Aspect 5 is the method of any of aspects 3 and 4, where a fourth threshold value is selected for the channel metric threshold in response to the indicator being associated with the backscattering-based communications device that receives the first transmission.

Aspect 6 is the method of any of aspects 3 to 5, where the SCI includes an indicator associated with a type of destination device that receives the first transmission. The indicator may be associated with a UE decoding capability of a second UE. A third threshold value may be selected for the channel metric threshold based on the UE decoding capability of the second UE.

Aspect 7 is the method of aspect 6, where the SCI further indicates the UE decoding capability.

Aspect 8 is the method of any of aspects 6 and 7, further including receiving, from the second UE, information indicating the UE decoding capability.

Aspect 9 is the method of any of aspects 6 to 8, where the UE decoding capability includes a capability to cancel a CW signal.

Aspect 10 is the method of aspect 9, where the resources of the second transmission include resources that overlap with the CW signal.

Aspect 11 is the method of any of aspects 1 to 10, where the SCI indicates a tag class for the backscattering-based communications device.

Aspect 12 is the method of aspect 11, further including selecting the lower RSRP threshold value or the higher RSRP threshold value for the RSRP threshold based on a reflection ability of the tag class.

Aspect 13 is the method of any of aspects 11 and 12, where a fifth threshold value may be selected for the channel metric threshold based on a reflection ability of the tag class

Aspect 14 is the method of any of aspects 11 to 13, where a sixth threshold value may be selected for the channel metric threshold based on an energy loss of the tag class.

Aspect 15 is the method of any of aspects 11 to 14, where the resources selected for transmitting the second transmission do not overlap with a frequency range of the tag class.

Aspect 16 is the method of any of aspects 11 to 15, further including receiving the SCI for the first transmission by receiving the SCI for the first transmission from a second UE.

Aspect 17 is the method of any of aspects 11 to 15, further including receiving the SCI for the first transmission by receiving the SCI for the first transmission from the backscattering-based communications device.

Aspect 18 is the method of any of aspects 1 to 17, where the SCI includes an indication of a presence of the backscattering-based communications device or an operation to read from the backscattering-based communications device. A seventh threshold value may be selected for the channel metric threshold based on the indication of the presence of the backscattering-based communications device or based on the operation to read from the backscattering-based communications device.

Aspect 19 is the method of any of aspects 1 to 18, where the SCI includes a first indication of the first threshold value and a second indication of the second threshold value.

Aspect 20 is the method of any of aspects 1 to 19, further including selecting a threshold increment from a first increment value and a second increment value based on the SCI. The first increment value may be different from the second increment value. The method may further include incrementing or decrementing or decrement the threshold value by the threshold increment in response to determining that available resources that do not overlap with the first transmission are less than or equal to a resource threshold.

Aspect 21 is the method of any of aspects 1 to 20, where an eighth threshold value may be selected for the channel metric threshold in response to a destination device of the second transmission being a second UE.

Aspect 22 is the method of any of aspects 1 to 21, where a ninth threshold value may be selected for the channel metric threshold in response to a destination device of the second transmission being a second backscattering-based communications device.

Aspect 23 is the method of any of aspects 1 to 22, where the backscattering-based communications device includes an RFID tag.

Aspect 24 is the method of any of aspects 1 to 23, where the second transmission includes a CW configuration having a single tone waveform, a multi-tone waveform, an OFDM waveform, or an SC waveform.

Aspect 25 is the method of any of aspects 1 to 24, where the channel metric includes an RSRP, an RSRQ, an SINR, a number of retransmissions, a T400 timer, a number of consecutive HARQ DTXs, or an integrity check measurement

Aspect 26 is a method of wireless communication, including transmitting an SCI for a transmission. The SCI may indicate that the transmission is associated with a backscattering-based communications device. The method may further include transmitting the transmission.

Aspect 27 is the method of aspect 26, where the SCI includes an indicator indicating the backscattering-based communications device as either a source or a destination of the transmission.

Aspect 28 is the method of any of aspects 26 and 27, where the SCI further indicates a UE decoding capability.

Aspect 29 is the method of any of aspects 26 to 28, where the SCI indicates a tag class for the backscattering-based communications device associated with the transmission.

Aspect 30 is the method of any of aspects 26 to 29, where the SCI includes an indication of a presence of the backscattering-based communications device or an operation to read from the backscattering-based communications device.

Aspect 31 is the method of any of aspects 6 to 30, where the SCI includes a first indication of a first threshold value for a channel metric threshold and a second indication of a second threshold value for the channel metric threshold.

What is claimed is:

1. An apparatus for wireless communication at a user equipment (UE), comprising:
a memory; and
at least one processor coupled to the memory and, based at least in part on information stored in the memory, the at least one processor is configured to:
receive a sidelink control information (SCI) for a first transmission;
select a threshold value for a channel metric threshold, wherein a first threshold value is selected for the channel metric threshold if the SCI indicates that the first transmission is associated with a backscattering-based communications device, wherein a second threshold value is selected for the channel metric threshold if the SCI indicates that the first transmission is not associated with the backscattering-based communications device, and wherein the first threshold value is different from the second threshold value;
measure at least a portion of the first transmission to generate a channel metric associated with the first transmission; and
transmit a second transmission using resources selected based on the channel metric and the channel metric threshold.

2. The apparatus of claim 1, further comprising a transceiver coupled to the at least one processor, wherein the at least one processor is further configured to:
transmit, using the transceiver, the second transmission using resources that overlap with the first transmission in response to the channel metric being less than the channel metric threshold and using resources that do not overlap with the first transmission in response to the channel metric being greater than the channel metric threshold; or
transmit, using the transceiver, the second transmission using resources that overlap with the first transmission in response to the channel metric being greater than the channel metric threshold and using resources that do not overlap with the first transmission in response to the channel metric being less than the channel metric threshold.

3. The apparatus of claim 1, wherein the SCI comprises an indicator associated with a type of destination device that receives the first transmission, and wherein a third threshold value is selected for the channel metric threshold in response to the indicator being associated with a second UE that receives the first transmission.

4. The apparatus of claim 1, wherein the SCI comprises an indicator associated with a type of destination device that receives the first transmission, and wherein a third threshold value is selected for the channel metric threshold in response to the indicator being associated with the backscattering-based communications device that receives the first transmission.

5. The apparatus of claim 1, wherein the SCI comprises an indicator associated with a type of destination device that receives the first transmission, wherein the indicator is associated with a UE decoding capability of a second UE, and wherein a third threshold value is selected for the channel metric threshold based on the UE decoding capability of the second UE.

6. The apparatus of claim 5, wherein the SCI further indicates the UE decoding capability.

7. The apparatus of claim 5, wherein the at least one processor is further configured to receive, from the second UE, information indicating the UE decoding capability.

8. The apparatus of claim 5, wherein the UE decoding capability comprises a capability to cancel a continuous wave (CW) signal.

9. The apparatus of claim 8, wherein the resources of the second transmission comprise resources that overlap with the CW signal.

10. The apparatus of claim 1, wherein the SCI indicates a tag class for the backscattering-based communications device, and wherein a third threshold value is selected for the channel metric threshold based on a reflection ability of the tag class.

11. The apparatus of claim 1, wherein the SCI indicates a tag class for the backscattering-based communications device, and wherein a third threshold value is selected for the channel metric threshold based on an energy loss of the tag class.

12. The apparatus of claim 1, wherein the SCI indicates a tag class for the backscattering-based communications device and wherein the resources selected for transmitting the second transmission do not overlap with a frequency range of the tag class.

13. The apparatus of claim 1, wherein the SCI indicates a tag class for the backscattering-based communications device and wherein the at least one processor is further configured to receive the SCI for the first transmission by receiving the SCI for the first transmission from a second UE.

14. The apparatus of claim 1, wherein the SCI indicates a tag class for the backscattering-based communications device and wherein the at least one processor is further configured to receive the SCI for the first transmission by receiving the SCI for the first transmission from the backscattering-based communications device.

15. The apparatus of claim 1, wherein the SCI comprises an indication of a presence of the backscattering-based communications device or an operation to read from the backscattering-based communications device, and wherein a third threshold value is selected for the channel metric threshold based on the indication of the presence of the backscattering-based communications device or based on the operation to read from the backscattering-based communications device.

16. The apparatus of claim 1, wherein the SCI comprises a first indication of the first threshold value and a second indication of the second threshold value.

17. The apparatus of claim 1, wherein the at least one processor is further configured to:
select a threshold increment from a first increment value and a second increment value based on the SCI, wherein the first increment value is different from the second increment value; and
increment or decrement the threshold value by the threshold increment in response to determining that available resources that do not overlap with the first transmission are less than or equal to a resource threshold.

18. The apparatus of claim 1, wherein a third threshold value is selected for the channel metric threshold in response to a destination device of the second transmission being a second UE.

19. The apparatus of claim 1, wherein a third threshold value is selected for the channel metric threshold in response to a destination device of the second transmission being a second backscattering-based communications device.

20. The apparatus of claim 1, wherein the backscattering-based communications device comprises an RFID tag.

21. The apparatus of claim 1, wherein the second transmission comprises a CW configuration having a single tone waveform, a multi-tone waveform, an orthogonal frequency division multiplexing (OFDM) waveform, or a single carrier (SC) waveform.

22. The apparatus of claim 1, wherein the channel metric comprises a reference signal receive power (RSRP), a received signal received quality (RSRQ), a signal-to-interference-plus-noise ratio (SINR), a number of retransmissions, a T400 timer, a number of consecutive hybrid automatic repeat request (HARQ) discontinuous transmissions (DTXs), or an integrity check measurement.

23. An apparatus for wireless communication, comprising:
a memory; and
at least one processor coupled to the memory and, based at least in part on information stored in the memory, the at least one processor is configured to:
transmit a sidelink control information (SCI) for a transmission, the SCI indicating that the transmission is associated with a backscattering-based communications device; and
transmit the transmission.

24. The apparatus of claim 23, wherein the SCI comprises an indicator indicating the backscattering-based communications device as either a source or a destination of the transmission.

25. The apparatus of claim 23, wherein the SCI further indicates a UE decoding capability.

26. The apparatus of claim 23, wherein the SCI indicates a tag class for the backscattering-based communications device associated with the transmission.

27. The apparatus of claim 23, wherein the SCI comprises an indication of a presence of the backscattering-based communications device or an operation to read from the backscattering-based communications device.

28. The apparatus of claim 23, further comprising a transceiver coupled to the at least one processor, wherein the at least one processor is further configured to transmit the SCI using the transceiver, wherein the SCI comprises a first indication of a first threshold value for a channel metric threshold and a second indication of a second threshold value for the channel metric threshold.

29. A method of wireless communication at a user equipment (UE), comprising:
receiving a sidelink control information (SCI) for a first transmission;
selecting a threshold value for a channel metric threshold, wherein a first threshold value is selected for the channel metric threshold if the SCI indicates that the first transmission is associated with a backscattering-based communications device, wherein a second threshold value is selected for the channel metric threshold if the SCI indicates that the first transmission is not associated with the backscattering-based communications device, and wherein the first threshold value is different from the second threshold value;
measuring at least a portion of the first transmission to generate a channel metric associated with the first transmission; and
transmitting a second transmission using resources selected based on the channel metric and the channel metric threshold.

30. A method of wireless communication, comprising:
transmitting a first sidelink control information (SCI) for a transmission, the SCI indicating that the transmission is associated with a backscattering-based communications device; and
transmitting the transmission.
